(19) United States
(12) Patent Application Publication
(10) Pub. No.: US 2015/0189457 A1
(43) Pub. Date: Jul. 2, 2015

(54) INTERACTIVE POSITIONING OF PERCEIVED AUDIO SOURCES IN A TRANSFORMED REPRODUCED SOUND FIELD INCLUDING MODIFIED REPRODUCTIONS OF MULTIPLE SOUND FIELDS

(71) Applicant: Thomas Alan Donaldson, Nailsworth (GB)

(72) Inventor: Thomas Alan Donaldson, Nailsworth (GB)

(73) Assignee: AliphCom, San Francisco, CA (US)

(21) Appl. No.: 14/144,518

(22) Filed: Dec. 30, 2013

(51) Int. Cl. H04S 7/00

(52) U.S. Cl. CPC H04S 7/303

(57) ABSTRACT

Embodiments relate generally to electrical and electronic hardware, computer software, wired and wireless network communications, and media devices or wearable/mobile computing devices configured to facilitate control of modifications of perceived directions from which sound in spatial audio originates. More specifically, disclosed are systems, devices and methods to facilitate control of the positioning of perceived audio sources, such as one or more speaking persons or listeners, to modify perceived directions or positions from which audio perceptibly originates in a transformed reproduced sound field. A method includes receiving audio streams originating from separate remote sound fields, and receiving a signal to cause a translatable portion to translate relative to one or more reproduce sound fields. Also, the method can include transforming a reproduced sound field in which the translated portion is disposed, and causing transducers to project sound beams to form an audio space at which spatial audio is produced.

### CROSS-REFERENCE TO RELATED APPLICATIONS

This application is co-related to U.S. Nonprovisional patent application Ser. No. 13/xxx,xxx, filed Dec. 30, 2013 with Attorney Docket No. ALI-199, and entitled “Transformation of Multiple Sound Fields to Generate a Transformed Reproduced Sound Field Including Modified Reproductions of the Multiple Sound Fields,” which is herein incorporated by reference in its entirety and for all purposes.

### FIELD

Embodiments relate generally to electrical and electronic hardware, computer software, wired and wireless network communications, and media devices or wearable/mobile computing devices configured to facilitate control of modifications of perceived directions from which sound in spatial audio originates. More specifically, disclosed are systems, devices and methods to facilitate control of the positioning of perceived audio sources, such as one or more speaking persons or listeners, to modify perceived directions or positions from which audio perceptibly originates in a transformed reproduced sound field.

### BACKGROUND

Conventional telecommunication and network communication devices, such as traditional teleconference equipment, enable remote groups of users to communicate with each other over distances via various types of communications medium, including phone lines, IP networks, etc. While are functional, there are various drawbacks to using conventional telecommunication and network communication devices and systems.

At least one drawback is that a listener participating in a teleconference may not be able to readily discern the identity of a person who is speaking remotely. Without knowing the identity of the person speaking (or the source of audio), the listener lacks information that may be used to fully comprehend the subject matter or the context of collaborative communications. Such a listener may be reticent to engage in a conversation or activity when a person raising an issue is unidentifiable aurally. Another drawback is that imperceptible voice audio originating at a remote location might cause a listener to expend effort to comprehend what is being said, especially when the listener tries to determine the identity of the person speaking. For instance, a user might expend significant effort to try determine whether a person speaking with an accent is either a foreign colleague or client, etc.

Yet another drawback of conventional audio communication systems, including teleconference equipment, is that known systems are sub-optimal to assist a listener with influencing the manner in which a listener senses an origination of voiced audio from a remote speaking person. In some cases, conventional teleconference equipment is not well-suited to facilitate the immersion of a listener in spatial audio at distances from the loudspeakers of the conventional teleconference equipment.

Thus, what is needed is a solution for providing interactive control to modify directions and/or positions of perceived audio sources associated with, for example, spatial audio that is presented to a listener in a region, without the limitations of conventional techniques.

### BRIEF DESCRIPTION OF THE DRAWINGS

Various embodiments or examples (“examples”) of the invention are disclosed in the following detailed description and the accompanying drawings:

FIG. 1A illustrates an example of a media device configured to control transformation of multiple sound fields for forming a transformed reproduced sound field at a region, according to some embodiments;

FIG. 1B illustrates examples of various implementations of an interface and a controller, according to various embodiments;

FIG. 1C depicts an interface configured to modify sizes of transformed sound fields, according to some examples;

FIG. 2 depicts an example of an interface configured to translate a reproduced sound field, according to some examples;

FIG. 3 is a diagram depicting an example of a reproduced sound field translator, according to some embodiments;

FIG. 4 is a diagram depicting an example of an interface controller and an audio space translator, according to some embodiments;

FIG. 5 is a diagram depicting an example of an audio space translator, according to some embodiments;

FIG. 6 is a diagram depicting an example of an interface controller and a private audio space communicator, according to some embodiments;

FIG. 7 is a diagram depicting a private audio space communicator, according to some examples;

FIG. 8 illustrates an example of a media device configured to form a transformed reproduced sound field, responsive to interface-originated signals, based on multiple audio streams associated with different media devices, according to some embodiments;

FIG. 9 depicts an example of a media device including a controller configured to determine position data and/or identification data regarding one or more audio sources, according to some embodiments

FIG. 10 is an example flow of controlling transformation of sound fields to include translated portions, according to some embodiments; and

FIG. 11 illustrates an exemplary computing platform disposed in a media device, a wearable device, or a mobile computing device in accordance with various embodiments.

### DETAILED DESCRIPTION

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

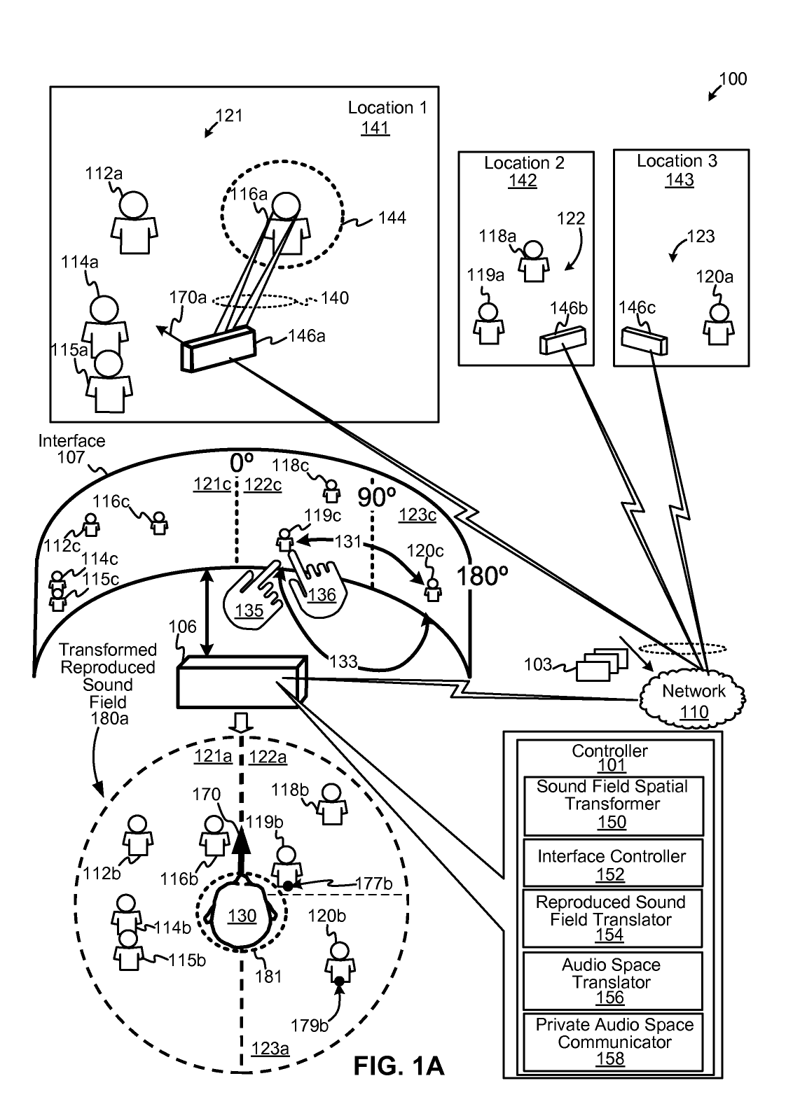

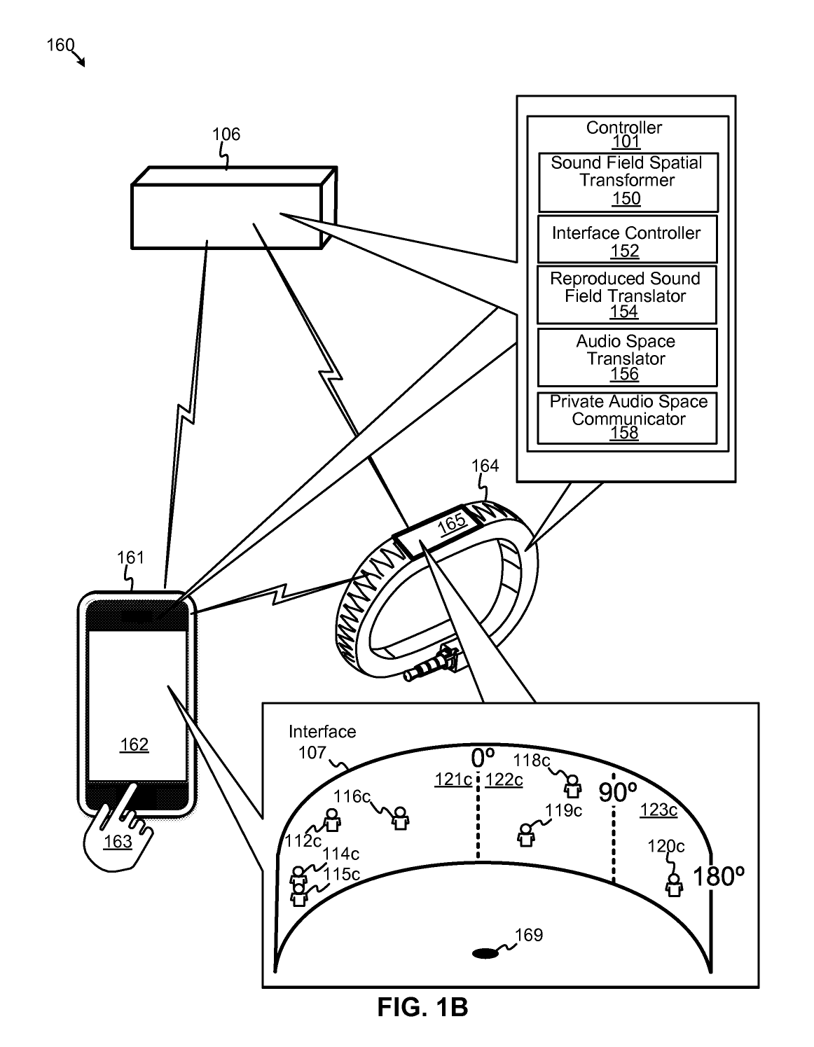

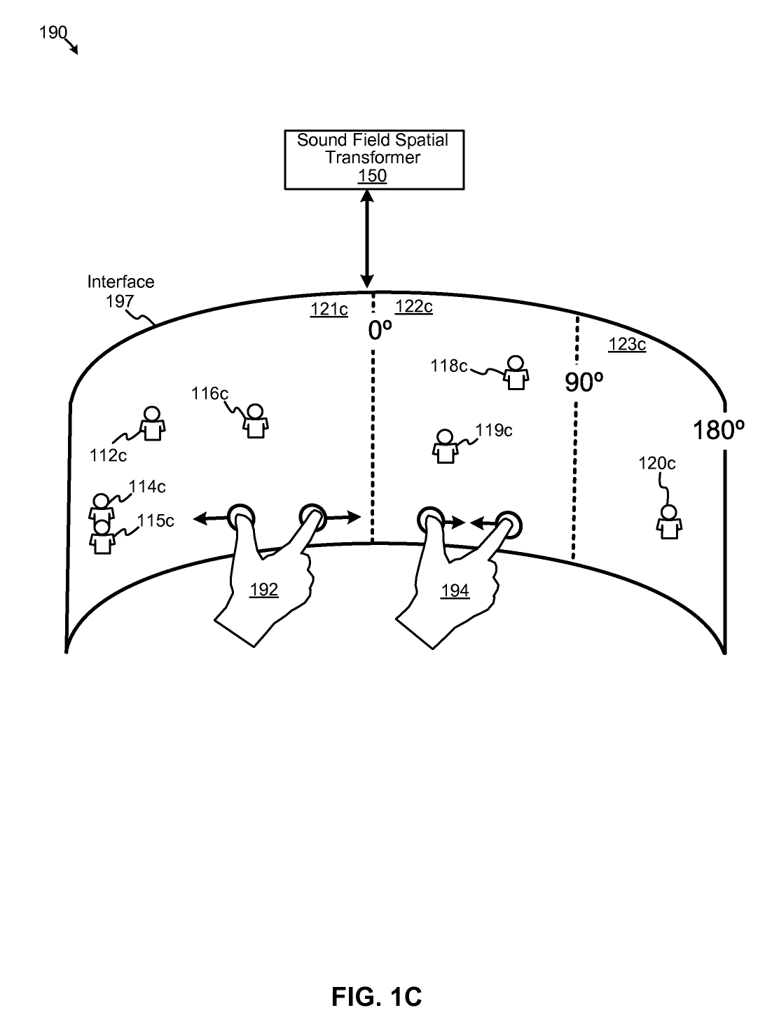

FIG. 1A illustrates an example of a media device configured to control transformation of multiple sound fields to effect movement of translatable perceived audio sources, according to some embodiments. According to various examples, a recipient 130 can receive audio that is perceived to originate from positions of remote audio sources as if the recipient was in the same room or location, whereby a controller enables the recipient to interact with an interface to move or translocate a perceived origin of an audio source adjacent recipient 130. Diagram 100 depicts a media device 106 configured to receive audio data 103 (e.g., via network 110) from remote audio sources for presentation as audio to recipient or listener 130. Examples of audio data 103 include audio from one or more remote sources of audio, or audio in recorded form stored in, or extracted from, a readable medium. Further, audio data 103 can include data representing spatial audio (e.g., 2-D or 3-D audio) and/or binaural audio signals, stereo audio signals, monaural audio signals, and the like. Media device 106 is further configured to generate a transformed reproduced sound field 180a in which recipient 130 can perceive remote groups of audio sources (e.g., audio sources 112a to 120a) as originating from different directions in a region at which recipient 130 is located. For example, media device 106 can generate acoustic signals as spatial audio that can form an impression or a perception at the ears of listener 130 that sounds are coming from perceived audio sources (e.g., audio sources 112b to 120b) that are perceived to be disposed/positioned in a region (e.g., 2D or 3D space) that includes recipient 130, rather than being perceived as originating from locations of two or more loudspeakers in the media device 106. Diagram 100 also depicts media device 106 including a controller 101 communicatively coupled to an interface 107, whereby interface 107 provides a means by which a user, such as recipient 130, can modify the transformed reproduced sound field 180a to reorient or translocate one or more directions/positions from which audio is perceived to originate from positions associated with audio sources 112b to 120b.

Controller 101 and interface 107 are configured to cooperate to receive instructions that cause a translatable portion of a reproduced sound field or a transformed reproduced sound field to translate from a first portion of interface 107 to a second portion, and responsive to such translation, controller 101 is configure to modify the perceived directions/positions associated with the translatable portion. In some embodiments, the term “translatable portion” can refer, at least in some cases, to a portion of interface 107 and/or a portion of either a reproduced sound field or a transformed reproduced sound field that is configurable such that one or more perceived audio sources can be “translocated,” “reoriented,” “moved,” and/or “relocated” with respect to directions/positions of perceived audio. The perceived positions can assist recipient 130 in determining an identity of a remote audio source (e.g., one of audio sources 112a to 120a) from which a voice or other audio originates, as well as other information. In some examples, controller 101 also includes or communicates with a reproduced sound field translator 154, an audio space translator 156, and a private audio space communicator 158.

Diagram 100 also depicts at least three different locations at which different groups of audio sources generate audio that is transmitted to media device 106. A first location (“Location 1”) 141 includes a group of audio sources 112a, 114a, 115a, and 116a, a second location (“Location 2”) 142 includes another group of audio sources 118a and 119a, and a third location (“Location 3”) 143 includes another group of audio sources including audio source 120a. Examples of such audio sources include one or more speaking persons or listeners, and can include any other sources of sound. Media devices 146a, 146b, and 146c can be disposed at locations 141, 142, and 143, respectively, to receive and/or produce sound waves in sound fields 121, 122, and 123, which are regions or areas including audible sound waves generated by, for example, any of audio sources 112a to 120a. In some examples, arrangements of the audio sources disposed in sound fields 121 to 123 may correlate to characteristics of sound fields 121 to 123, such as the corresponding sound field sizes, distribution/positioning of audio sources in the sound fields, etc. Further, each of media devices 146a to 146c can be coextensive with a point of reference (i.e., a reference point located in the center of the media device) from which positions of remote audio sources can be described.

Further to FIG. 1A, diagram 100 depicts controller 101 including a sound field spatial transformer 150, which is configured to operate on audio data 103 to facilitate generation of transformed reproduced sound field 180a. Controller 101 also includes an interface controller 152 configured to facilitate reorientation or modification of one or more directions/positions from which audio is perceived to originate from any of audio sources 112b to 120b in transformed reproduced sound field 180a. Sound field spatial transformer 150 is configured to transform one or more spatial characteristics, including one or more dimensions (e.g., spatial dimensions) and/or attributes/characteristics associated with sound fields 121, 122, and 123 to form respective transformed sound fields that can be used to form a transformed sound field (e.g., a collective transformed sound field), such as transformed reproduced sound field 180a. According to some examples, sound field spatial transformer 150 transforms spatial characteristics (e.g., spatial dimensions) of sound fields 121, 122, and 123, such as the size of an area (or perceived area) of a sound field. For example, an area (or perceived area) of a sound field can be described as a sector having an area (e.g., including audio sources) bounded by two radii (“r”) that are displaced by an angle.

To illustrate an operation of sound field spatial transformer 150, consider an example in which recipient 130 is disposed at one of locations 141, 142, and 143 as a substitute for respective media devices 146a, 146b, and 146c. First consider that in diagram 100, recipient 130 and its auditory systems (e.g., outer ear portions, including pinnae, etc.) face or are oriented toward a direction defined by reference line 170. In this position, recipient 130 is in a region adjacent to media device 106, which is configured to generate transformed reproduce sound field 180a that includes spatially transformed reproductions of sound fields 121, 122, and 123. Next, consider a specific instance in which only sound field 121 is reproduced by sound field spatial transformer 150 (i.e., without reproductions of sound fields 122 and 123). In this case, audio sources 112b to 116b can be perceived by recipient 130 in transformed reproduce sound field 180a as if positioned (or spatially arranged) as shown in location 141. That is, recipient 130 perceives that it is disposed as a substitute (not shown) for media device 146a in location 141 facing in a direction indicated by a reference line 170a. In this orientation, the recipient perceives a spatial arrangement of audio sources 112a, 114a, 115a, and 116a as producing audio in sound field 121. Similarly, reproductions of sound fields 122 and 123 can be generated individually so that recipient 130 perceives the reproductions produced by media device 106 as if recipient 130 was disposed as a substitute for media devices 146b and 146c, respectively. Further, consider that sound field spatial transformer 150 collectively generates reproductions of sound fields 121, 122, and 123, and transforms the reproduced versions of sound fields 121, 122 and 123 so that recipient 130 can perceptibly detect, for example, separate groups of spatial arrangements for perceived audio sources 112b to 116b, perceived audio sources 118b and 119b, and perceived audio source 120 as separate groups.

In particular, sound field spatial transformer 150 can transform the reproduced versions of sound fields 121 to 123 to form transformed sound fields. Note that, as an example, recipient 130, as a result of transformation, may perceive an alteration or transformation in the directions from which audio originates from perceived audio sources 112b to 116b as compared to the directions from which audio originates from audio sources 112a to 116a in the original sound field 121 relative to the reference point/media device 146a. Therefore, sound field spatial transformer 150 can operate to reorient the perceived directions from which remote voices or sounds emanate. Accordingly, transformed reproduced sound field 180a can be formed by combining transformed sound fields 121a, 122a, and 123a. As shown, recipient 130 therefore perceives remote audio sources 112a, 114a, 115a, and 116a as being positioned at perceived audio sources 112b, 114b, 115b, and 116b in a reproduced sound field that spans approximately 180° (e.g., on the left side of recipient 130 from the rear to the front, which is indicated by the direction of reference line 170). By contrast, recipient 130 perceives remote audio sources 118a and 119a as being positioned at perceived audio sources 118b and 119b in reproduced sound field 122a that spans approximately 90° (e.g., on the front-right side of recipient 130), and perceives remote audio source 120a as being positioned at perceived audio source 120b in reproduced sound field 123a that spans approximately 90° (e.g., on the back-right side of recipient 130).

Sound field spatial transformer 150 is configured to transform individual sound fields and combine them to form, for example, a single, collective, or unitary transformed reproduced sound field, according to some examples. Thus, sound field spatial transformer 150 can operate to combine, integrate, conjoin (e.g., by joining monolithic transformed sound fields), mix (e.g., interlace or interleave transformed sound fields and/or perceived audio sources 112b to 120b with each other), or otherwise implement multiple transformed sound fields in a variety of ways to form a transformed reproduced sound field 180a. Such a transformed reproduced sound field includes aural cues and other audio-related information to enable recipient 130 to perceive the positions of remote audio sources as they are arranged spatially in a remote sound field.

Interface 107 and interface controller 152 are configured to cooperate to determine one or more parameters with which to provide sound field spatial transformer 150 (or any of reproduced sound field translator 154, audio space translator 156, and private audio space communicator 158), according to various embodiments. In turn, sound field spatial transformer 150 uses the one or more parameters to transform one or more sound fields or reproduced sound fields as a function of one or more parameters. As shown, audio sources 112a to 116a can be represented by icons 112c to 116c (or by any other representations) as respective remote audio sources. Icons 112c to 116c are disposed in a portion 121c of interface 107 to indicate that they are associated with sound field 121a. Similarly, audio sources 118a to 120a can be represented by icons 118c to 120c as respective audio sources. Icons 118c and 119c are disposed in a portion 122c of interface 107 and icon 120c is disposed in portion 123c of interface 107 to indicate that they are associated with sound fields 122a and 123a, respectively. In this example, a portion 121c of interface 107 displays audio sources that are perceived to be disposed in transformed sound field 121a (e.g., a 180° sector to the left of recipient 130), whereas portions 122c and 123c of interface 107 display audio sources that are perceived to be disposed in transformed sound fields 122a and 123a, respectively (e.g., in two 90° sectors the right of recipient 130). Note that in various examples, interface controller 152 is configured to detect selection of the translatable portion of interface 107 whereby the translatable portion can represent be represented by one or more icons, such as icons 112c to 116c, or one or more portions of interface 107, such as a portion 121c associated with a sound field.

Interface 107 is configured to detect one or more interactions 135 by a user, whereby one or more parameters can be determined responsive to such interactions. Such parameters are used by sound field spatial transformer 150 to modify the direction/positions of perceived sources of audio in transformed reproduce sound field 180a in real-time (or substantially in real-time). According to various examples, interface 107 and/or interface controller 152 can communicatively exchange data with reproduced sound field translator 154, which is configured to translate or relocate one or more reproduced sound fields (or transformed sound fields) in transformed reproduce sound field 180a. For example, interface controller 152 can receive signals representing the selection by user or user interaction 135 of portion 122c of interface 107, and signals representing the translation of portion 122c to another location in interface 107. As shown, user 135 selects portion 122c and performs a move operation 133 in which portion 122c is translated. In some instances, reproduced sound field translator 154 can swap locations of portions 122c and 123c on interface 107 responsive to the placement of portion 122c. Interface controller 152 detects a request to translate a portion of interface 107, the requesting including data representing an amount of translation and a destination portion of interface 107. The request and data are provided to reproduced sound field translator 154, which is configured to translate one or more reproduced sound fields to form transformed sound fields responsive to interactions with interface 107. In this case, swapping portions 122c and 123c causes sound field spatial transformer 150 to swap locations of transformed sound fields 122a and 123a in transformed reproduced sound field 180a. Perhaps user 135 performs the swap operation to dispose perceived audio source 120b in the front-right quadrant because perceived audio source 120b is more important to recipient 130 (e.g., user 135) than perceived audio sources 118b and 119b, which are then disposed in the back-right quadrant.

According to various examples, interface 107 and/or interface controller 152 can communicatively exchange data with audio space translator 156, which is configured to translate, orientate, move, position, and/or relocate one or more audio sources (or audio spaces) in transformed reproduce sound field 180a. As another example, interface controller 152 can receive signals representing the selection of icon 119c by user or user interaction 136 (e.g., a swiping motion across interface 107) and the translation of icon 119c to another location in interface 107. As shown, user or user interaction 136 selects icon 119c and performs a translocation operation 131 in which icons 119c is moved or repositioned on interface 107. In some cases, audio space translator 156 can swap icons 119c and 120c interface 107. Interface controller 152 detects a request to translocate an audio space/source, the request including data representing an amount of translation as well as a destination portion of interface 107. The request and data are transmitted to audio space translator 156, which is configured to determine an amount and direction in which translate one or more icons in interface 107. Audio space translator 156 is then configured to transmit data (e.g., an amount of translation, a beginning coordinate position (e.g., X1, Y1), a destination coordinate position (e.g., X2, Y2), and the like) to sound field spatial transformer 150, which, in turn, is configured to translate or relocate perceived audio sources in transformed reproduced sound field 180a as a function of the translated icons in interface 107. In an example in which icons 119c and 120c swap positions, audio space translator 156 causes sound field spatial transformer 150 to swap positions of perceived audio sources 119b and 120b in transformed reproduced sound field 180a (e.g., the perceived positions are swapped such that perceived audio source 119b is translated to position 179b and perceived audio source 120b is relocated to position 177b).

In at least some examples, interface 107 and/or interface controller 152 can communicatively exchange data with private audio space communicator 158, which is configured to convey audio to a remote participant, such as audio source/recipient 116a of location 141. For example, recipient 130 (e.g., as a user) can select icon 116c of interface 107 to initiate a private channel of communication to convey audio to only audio space 144, which is shown to include recipient 116a (e.g., to effect an equivalent to a “whisper mode” of operation). In some examples, media device 146a can be structurally and/or functionally similar to media device 106, which can include two or more loudspeakers or transducers configured to produce acoustic sound waves to form transformed reproduced sound field 180a. Sound field spatial transformer 150 of media device 106 can control transducers to project sound beams at a point in a region to form audio space 181 at which spatial audio is produced to present transformed reproduced sound field 180a to recipient 130. In some examples, media device 106 can determine the position of audio space 181, and steer at least a subset of the transducers to project the sound beams to the position of audio space 181. Therefore, the subset of transducers can steer spatial audio to any number of positions in a region adjacent media device 106 for presenting transformed reproduced sound field 180a to recipient 130.

Similarly, media device 146a can include a subset of transducers that are configured to steer sound beams 140 toward recipient 116a to form an audio space 144, which is isolated. That is, audio projected to audio space 144 is not audible (or substantially audible) at positions associated with audio sources/recipients 112a, 114a, and 115a. In some examples, data representing the position of audio source/recipient 116a can be exchanged between media devices 146a and 106. The data representing the position of audio source/recipient 116a may be used to convey a relative position of icon 116c relative to the spatial arrangement of other icons 112c, 114c, and 115c, which may or may not be proportional to the spatial arrangement of audio sources 112a, 114a, and 115b relative to the position of audio source/recipient 116a. Private audio space communicator 150 can determine the selection of icon 116c for purposes of establishing a private audio space for recipient 116a. In some cases, media device 106 transmits data indicating the presence of audio for a private communication and the identity of the recipient (e.g., audio source/recipient 116a). In some cases, media device 146a can access data representing a direction or position at which recipient 116a is disposed relative to reference line 170a, according to some examples. Thus, media device 146a can select a subset of transducers that can be controlled in a manner to steer sound beams 140, which include the audio of the private communication, toward a direction/position coincident with audio space 144.

In view of the foregoing, the functions and/or structures of media device 106 and/or interface 107, as well as their components, can facilitate modification or reorientation of one or more directions or positions from which the reproduction of one or more audio sources are perceived to originate through selection via interface 107. As media device 106 and media devices 146a to 146c can have two or more transducers, spatial audio need not be produced by earphones or other near-ear speaker systems. Further, interface 107 enables recipient 130 to arrange groups of perceived audio sources in a customized manner (e.g., from recipient's left to right, or from the recipient's front to back) so that the recipient can engage in collaborative telephonic discussions with groups of people at different locations using sound field spatial transformer 150, whereby the arrangement of the perceived audio sources provides supplemental information they can aid the listener in determining various aspects of the communication, such as the quality of information being delivered, the importance of the information delivered, the identity of a speaking person based on perceived position, and other factors with which to determine whether audio is important to the recipient 130. Therefore, recipient 130 need not rely solely on identifying a remote speaker's voice or identity to determine the relevance of information that is conveyed verbally. Recipient 130 then can focus its attention on the position of the perceived audio source to learn the critical information rather than losing focus or expending energy on deciphering which voice belongs to which remote audio source. Furthermore, recipient 130 can arrange icons 112c to 120c via interface 107 so that the recipient can readily identify the identities corresponding to each of the perceived positions of audio spaces 112b to 120b (and the perceived directions from which audio originates). By doing so, the recipient can respond more quickly and accurately not only based on the sound of the voice or the nature of the information conveyed but also, for example, by the origination of the audio, among other things, like the relationship of a speaking individual to the recipient 130, a location of the remote person that is speaking, etc. Note that other parameters are also possible to be determined via interface 107, and, as such, the above-described parameters (e.g., an initial point on interface 107, an amount of translation across interface 107, a destination point on interface 107, etc.) are not intended to be limiting. For example, user/recipient 130 can rearrange perceived audio sources in transformed reproduce sound field 180a based on the geographic locations of each of the remote locations, or the user use interface 107 to aurally dispose perceived audio sources in transformed reproduced sound field 180a based on the relationships of the remote participants with recipient 130 (e.g., based on an employee-employer relationship, a hierarchical relationship in an organization, a client relationship, a familial relationship, or the like). Or, recipient 130 can arrange the perceived audio sources in transformed reproduced sound field 180a based on the importance of the information exchanged with recipient 130 and a remote participant, or based on any other criteria.

Note that sound field spatial transformer 150 can transform other spatial dimensions that characterize or influence translation of reproduced or transformed sound fields, such as characteristics that describing a region (e.g., a sector) including size (e.g., in terms of one or more radii, or an angle that displaces the radii), and position of an audio source (e.g., in terms of a direction, such as an angle of a ray line relative to a remote reference line 170a). In some instances, a spatial dimension can describe a distance from a position to a reference line. Note, too, that a spatial dimension can be described in a polar coordinate system with ray lines, such as ray line 170 are presenting vectors. However, other implementations of the various examples need not be limited to a polar coordinate system.

In some cases, an audio stream from any of media devices 146a, 146b, and 146c can include data representing three-dimensional audio originating in a remote sound field (e.g., sound fields 141, 142, and 143) as binaural audio. However, sound field spatial transformer 150 need not be limited to receiving binaural or spatial audio. For example, sound field spatial transformer 150 can convert stereo signals (e.g., a left channel and right channel) into spatial audio for producing transformer reproduced sound field 180a. Therefore, any of media devices 146a, 146b, and 146c need not be required to include sound field spatial transformer 150 to produce transformed reproduced sound field 180a, at least in some examples. According to some embodiments, the term “reproduced sound field” can refer, in some examples, to spatial audio (e.g., 3-D audio) that is produced such that perceived audio sources are positioned substantially similar to the positions for remote audio sources in the original sound field. According to some embodiments, the term “transformed sound field” can refer, in some examples, to audio produced in a manner that a recipient can detect that perceived audio sources are positioned differently than those positions for remote audio sources in the original sound field (e.g., to due to transformation of spatial dimensions). Further, a transformed sound field can also refer to transformed sound fields based on reproduced sound fields (e.g., spatial audio) or sound fields that include non-spatial audio. In some cases, a transformed sound field includes perceived audio sources having a spatial arrangement that can be either scaled-up or scaled-down in terms of distances relative to each other.

Note that the above-described positions, whether actual (i.e., remote positions) or perceived (i.e., locally reproduced), can also be referred to as “audio space.” According to some example, the term “audio space” can refer to a two- or three-dimensional space in which sounds can be perceived by a listener as 2D or 3D spatial audio. The term “audio space” can also refer to a two- or three-dimensional space from which audio originates, such as a remote audio source being co-located in a remote audio space. For example, recipient 130 can perceive spatial audio in an audio space 181, and that same audio space (or variant thereof) can be associated with audio generated by recipient 130, such as during a teleconference. In some cases, the term “audio space” can be used interchangeably with the term “sweet spot.” An audio stream can refer to a collection of audio signals from one or more of a common sound field, individual audio signals from a common sound field, or any audio signal from any audio source. Note that while diagram 100 depicts media device 106 generating a circular-shaped transformed reproduced sound field 180a, it is not intended to be limiting. That is, transformed reproduced sound field 180a can be represented by a rectangle/grid-like region of space, or any other shape or coordinate system with which to identify and transform positions at which perceived audio sources can be disposed. Thus, sectors may be replaced by other types of areas, such as rectangular or square areas.

In some embodiments, controller 101 can be in communication (e.g., wired or wirelessly) with a mobile device, such as a mobile phone or computing device, or can be disposed in a mobile device and/or a media device. In some cases, a mobile device or any networked computing device (not shown) in communication with a media device including controller 101 can provide at least some of the structures and/or functions of any of the features described herein. As depicted in FIG. 1A and other figures, the structures and/or functions of any of the above-described features can be implemented in software, hardware, firmware, circuitry, or any combination thereof. Note that the structures and constituent elements above, as well as their functionality, may be aggregated or combined with one or more other structures or elements. Alternatively, the elements and their functionality may be subdivided into constituent sub-elements, if any. As software, at least some of the above-described techniques may be implemented using various types of programming or formatting languages, frameworks, syntax, applications, protocols, objects, or techniques. For example, at least one of the elements depicted in FIG. 1A (or any figure) can represent one or more algorithms. Or, at least one of the elements can represent a portion of logic including a portion of hardware configured to provide constituent structures and/or functionalities.

For example, controller 101 and any of its one or more components, such as sound field spatial transformer 150, interface controller 152, reproduced sound field translator 154, audio space translator 156, and private audio space communicator 158 can be implemented in one or more computing devices (i.e., any audio-producing device, such as desktop audio system (e.g., a Jambox® implementing LiveAudio® or a variant thereof), a mobile computing device, such as a wearable device or mobile phone (whether worn or carried), that include one or more processors configured to execute one or more algorithms in memory. Thus, at least some of the elements in FIG. 1A (or any figure) can represent one or more algorithms. Or, at least one of the elements can represent a portion of logic including a portion of hardware configured to provide constituent structures and/or functionalities. These can be varied and are not limited to the examples or descriptions provided.

As hardware and/or firmware, the above-described structures and techniques can be implemented using various types of programming or integrated circuit design languages, including hardware description languages, such as any register transfer language (“RTL”) configured to design field-programmable gate arrays (“FPGAs”), application-specific integrated circuits (“ASICs”), multi-chip modules, or any other type of integrated circuit. For example, controller 101 and any of its one or more components, such as sound field spatial transformer 150, interface controller 152, reproduced sound field translator 154, audio space translator 156, and private audio space communicator 158 can be implemented in one or more computing devices that include one or more circuits. Thus, at least one of the elements in FIG. 1A (or any figure) can represent one or more components of hardware. Or, at least one of the elements can represent a portion of logic including a portion of circuit configured to provide constituent structures and/or functionalities.

According to some embodiments, the term “circuit” can refer, for example, to any system including a number of components through which current flows to perform one or more functions, the components including discrete and complex components. Examples of discrete components include transistors, resistors, capacitors, inductors, diodes, and the like, and examples of complex components include memory, processors, analog circuits, digital circuits, and the like, including field-programmable gate arrays (“FPGAs”), application-specific integrated circuits (“ASICs”). Therefore, a circuit can include a system of electronic components and logic components (e.g., logic configured to execute instructions, such that a group of executable instructions of an algorithm, for example, and, thus, is a component of a circuit). According to some embodiments, the term “module” can refer, for example, to an algorithm or a portion thereof, and/or logic implemented in either hardware circuitry or software, or a combination thereof (i.e., a module can be implemented as a circuit). In some embodiments, algorithms and/or the memory in which the algorithms are stored are “components” of a circuit. Thus, the term “circuit” can also refer, for example, to a system of components, including algorithms. These can be varied and are not limited to the examples or descriptions provided.

FIG. 1B illustrates examples of various implementations of an interface and a controller, according to various embodiments. Diagram 160 includes similarly-named and similarly-numbered structures and/or functions as set forth in FIG. 1A, any of which can be implemented as described herein and can include more or fewer structures and/or functions. As shown, diagram 160 includes media device 106, a mobile communications and/or computing device 161, and a wearable computing device 164, among which interface 107 and/or controller 101 can be disposed. Interface 107 can be implemented as interface 162 of mobile device 161 as well as interface 165 of wearable device 164. Diagram 160 further depicts controller 101 including a sound field spatial transformer 150, an interface controller 152, a reproduced sound field translator 154, and audio space translator 156, and a private audio space communicator 158. Note that one or more components of controller 101 can be disposed or distributed in one or more of media device 106, mobile communications and/or computing device 161, and wearable computing device 164, as well any other structure/device not shown. Also note that while interface 107 is shown to have somewhat of a curved surface, such curvature, as illustrated, may depict a general positioning of perceived audio sources (e.g., on an inside wall of a half of a cylinder about point 169 at which a recipient may be disposed). Regardless, interface 162 may be formed as a curved or flat surface, or can be flexible to flex and bend.

FIG. 1C depicts an interface configured to modify sizes of transformed sound fields, according to some examples. Diagram 190 includes similarly-named and similarly-numbered structures and/or functions as set forth in FIG. 1A, any of which can be implemented as described herein and can include more or fewer structures and/or functions. In some examples, interface 197 maybe a touch-sensitive interface configured to implement multi-touch gestures as interactive inputs. For example, a first user interaction 192 can be a “pinch open” interaction that conveys a request to increase the size of the transformed sound field associated with portion 121c of interface 197, whereas a second user interaction 194 can be an “pinch close” interaction that conveys request to reduce the size of the transformed sound field associated with portion 122c of interface 197. Other interactions to modify other spatial dimensions are also possible. Further, interface 197 is not limited to a touch-sensitive screen but can be any graphic user interface, any auditory interface, any haptic interface, any combination thereof, and the like.

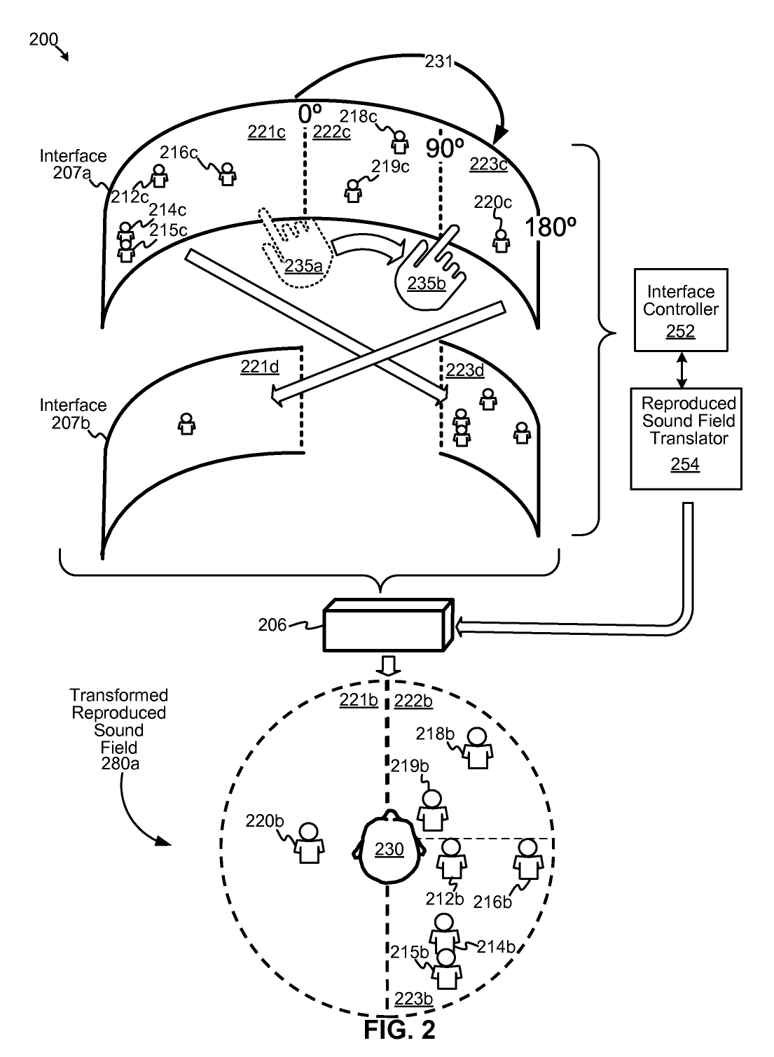

FIG. 2 depicts an example of an interface configured to translate a reproduced sound field, according to some examples. Diagram 200 depicts an interface controller 252 and a reproduced sound field translator 254 disposed in a media device 206, both of which cooperate to translate or otherwise reposition icons or other representations of reproduced sound fields in interface 207. As shown in FIG. 2, icons 212c to 216c depicted in portion 221c represent remote audio sources in a first remote sound field, icons 218c and 219c depicted in portion 222c represent another group of remote audio sources in a second remote sound field, and icon 220c depicted in a portion 223c represents a remote audio source in a third remote sound field. Although not shown, consider that media device 206 initially generates transformed reproduce sound field 280a with perceived audio sources 212b to 216b to the left of recipient 230, whereas perceived audio source 220b is initially disposed in the back-right quadrant.

Interface controller 252 is configured to receive signals including data representing one or more instructions to cause a translatable portion to translate, move, or relocate relative to locations depicted on interface 207a. In particular, the user wishes to relocate remote audio sources 212c to 216c to portion 223c of interface 207a. For example, the user may wish to translate audio sources 212c to 216c by an amount 231 to replace existing remote audio sources in portion 223c. As shown, interface controller 252 is configured to detect an interaction 235a that causes generation of a signal indicating selection of the translatable portion, such as portion 221c of interface 207a. Further, interface controller 252 can detect another interaction 235b indicating a destination for the translatable portion (e.g., after a user swipes a finger across a surface of the interface). In particular, interface controller 252 can detect receive a signal including data that represents a destination for the translatable portion, such as portion 223c. From these interactions, interface controller 152 can determine amount 231 to graphically displace the translatable portion including audio sources 212c to 216c (e.g., amount 231 can be expressed as a distance or a displacement in coordinates, such as X and Y coordinates, that conceptually can be superimposed upon its interface 207a).

Interface controller 252, therefore, can cause reproduced sound field translator 254 to translate a reproduced sound field from portion 221c of interface 207a, as a translatable portion, to portion 223d of interface 207b (i.e., interface 207a subsequent to the translation). Optionally, reproduced sound field translator 254 can be configured to relocate portion 223c of interface 207a, as a translatable portion, to a location of portion 221d of interface 207b. Movement of remote audio source 220c may be caused by initiation of a default swap operation, or can be initiated by the user. In some cases, remote audio source 220c remains in its current position as remote audio sources 212c to 216c are overlaid upon portion 223c. In at least one instance, remote audio source 220c can be moved within portion 223d to accommodate the spatial arrangement associated with remote audio sources 212c to 216c.

Responsive to interactions with the interface, reproduced sound field translator 254 is configured to dispose perceived audio sources 212b to 216b in portion 223b of transformed reproduced sound field 280a, and is further configured to dispose perceived audio source 220b in portion 221b. Reproduced sound field translator 254 can be configured to map perceived audio sources 212b to 216b from portion 221b to corresponding destination points in portion 223b so that, for example, a spatial arrangement of perceived audio sources 212b to 216b can be maintained (e.g., similar to the spatial arrangement depicted in portion 221c of interface 207a). Media device 206 is also configured to dispose perceived audio sources 218b and 219b in portion 222b of transformed reproduced sound field 280a. Note that while the sizes of portions 221b and 223b of transformed reproduced sound field 280a are depicted as being relatively proportion to, or substantially the same as, the sizes before the translation, this need not be the case. As such, media device 206 can be configured to increase the size of portion 223b to accommodate an increased number of remote audio sources 212b to 216b, or to decrease the size of portion 221b due to a single remote audio source 220b being disposed therein.

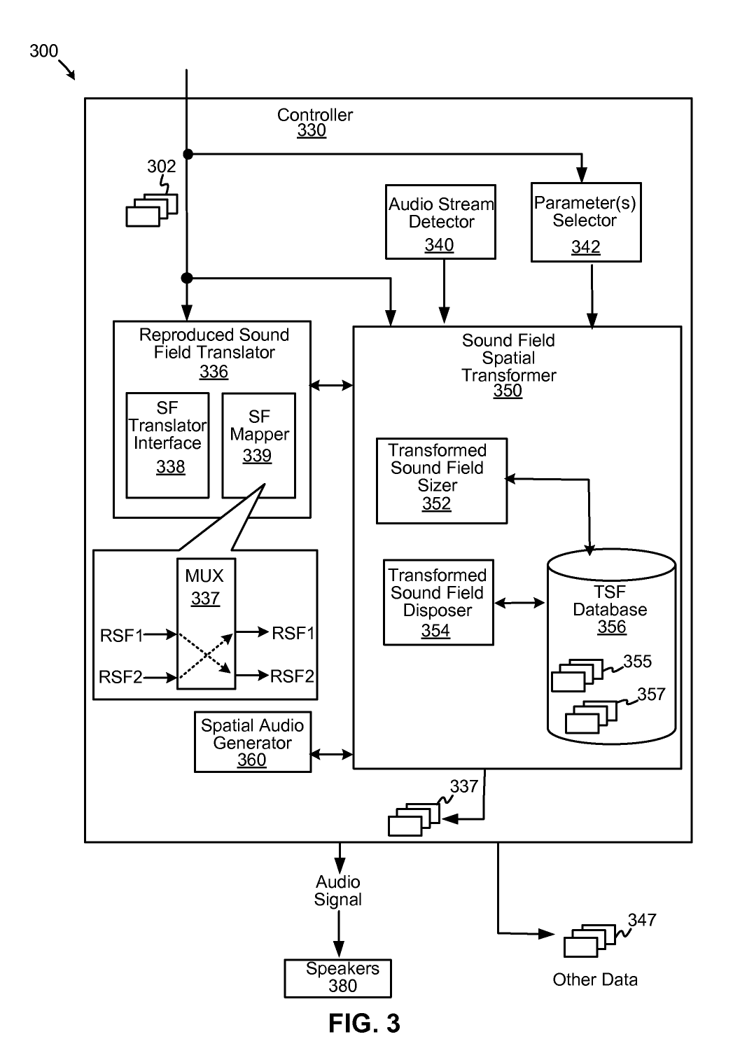

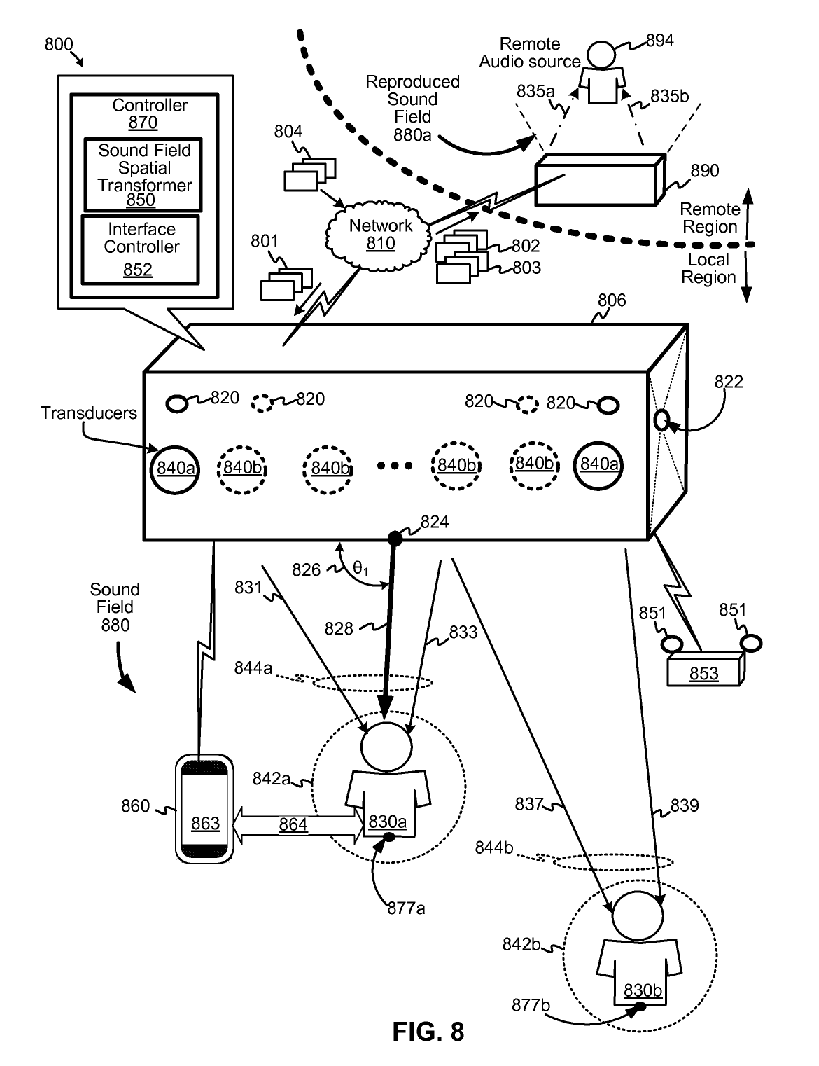

FIG. 3 is a diagram depicting an example of a reproduced sound field translator, according to some embodiments. Diagram 300 includes a controller 330, which, in turn, includes a reproduce sound field translator 336 and a sound field spatial transformer 350, as well as other components, such as an audio stream detector 340, a parameter selector 342, and a spatial audio generator 360. Spatial audio generator 360 can be configured to generate spatial audio based on audio received from microphones disposed in or otherwise associated with a local media device, whereby the spatial audio can be transmitted as audio data 337 to a remote location. Spatial audio generator 360 can receive audio data from a remote sound field, as well as optional control data (e.g., including spatial filter parameters for a cross-talk cancellation filter and other circuitry, position-related data, identification data, or the like), for converting audio received from a remote location (or a recorded medium) into spatial audio for transmission through speakers 380 to local listeners. Examples of spatial audio generation, including cross-talk cancellation filtering, are described herein, such as in relation to FIG. 8.

Audio stream detector 340 is configured to detect a quantity of audio streams at any specific point in time, and also determine a number of audio sources that are added or deleted from a collaborative communication, such as a teleconference. In some cases, the quantity of audio streams can be used by sound field spatial transformer 650 to determine a number of transformed sound fields, and, thus, a number of portions of a transformed reproduce sound field into which the transformed sound fields are to be disposed. In some examples, the number of audio sources in a remote sound field can influence the size of a reproduced sound field and/or a transformed sound field.

Parameter selector 342 is configured to select one or more parameters such as a location parameter, a relationship parameter, and importance-level parameter, and the like, whereby any of the parameters may be prioritized relative to each other. The one or more parameters can be received (e.g., data 302) via an interface to, for example, set of initial disposition of transformed sound fields as well as the default set of sizes of the same. An interface can further be used to receive selections interactively from a user to reorient or relocate perceived audio sources thereafter. For example, a relationship parameter defining a relation between the recipient and remote audio sources may be used to determine the size and disposal of transform sound fields as a priority over location parameters, as an example. According to some examples, parameter selector 342 can receive data 302 including one or more of the following parameters: an initial point on an interface (e.g., coordinates associated with an interaction indicating a selection), a destination point on the interface (e.g., coordinates associated with an interaction indicating a position to which to move the translatable portion), an amount of translation across the interface (distance between initial coordinates and destination coordinates), and the like. The parameters can be provided by a user via an interface, stored in a repository, and provided by other means.

Sound field spatial transformer 350 is shown to include transformed sound field sizer 352, a transformed sound field disposer 354, and a transformed sound field (“TSF”) database 356. Sound field spatial transformer 350 is configured to transform individual sound fields (e.g., individual reproduced sound field) and combine them to form, for example, a collective transformed reproduced sound field. Transformed sound field sizer 352 is configured to modify the size for a transformed sound field as a function of one or more parameters including a quantity of audio streams that are detected by audio stream detector 340. In some examples, the size of a transformed sound field can be sized proportionate to the number of audio sources disposed therein (e.g., higher quantities of audio sources associated with a transformed sound field can lead to an increased size). In further examples, transformed sound field sizer 352 can be configured to modify other characteristics of a transformed sound field by receiving signals via an interface controller from an interface. Examples of such signals include those generated by the interface responsive to interactions such as those depicted in FIG. 1C.

Note that in some embodiments, one or more head related transfer functions (“HRTFs”) and coefficients thereof, as well as other related data, can be modeled and interpolated to, for example, scale distance relationships between reproduced audio sources (e.g., virtual audio sources). As an example, azimuth and elevation angles, as well as interaural time differences (“ITDs”) and interaural level differences (“ILD”), among other parameters (e.g., HRTF parameters), can be modeled and scaled to mimic or otherwise transform a reproduced sound field with the size perceptibly different than in the original sound field. Transformed sound field sizer 352 can implement HRTF-related filters (e.g., FIR filters and coefficients, etc.) and transforms (e.g., Fourier transforms, etc.) to produce perceived audio sources in a transformed sound field that are sized differently than the original sound field. Transformed sound field sizer 352 can access size definition data 355 in database 356, whereby size definition data 355 includes data describing the effects of different parameter data on changing the size of a transformed sound field. In some cases, modification of size may be based on multiple parameters each of which can be weighted in accordance with weighted values defined in size definition data 355. For example, an angle between two radii as well as each length of one of the radii may be modified proportionately when resizing a region or sector based on a weighting indicative of a number of remote audio sources associated with the region, among other things.

Transformed sound field disposer 354 is configured to transform or otherwise reorient perceived directions of perceived audio sources for a reproduced sound field to another orientation such that a recipient perceives audio originating from directions different than that captured at a remote sound field. For example, if audio sources are perceived to originate at 30° from a reference vector in a remote sound field, transformed sound field disposer 354 can be configured to dispose a transformed version of the original sound field (e.g., “transformed sound field”) in a region local to a recipient (e.g., in a portion of the transformed reproduced sound field) such that the recipient perceives the audio originating from a different direction other than 30° relative to an equivalent of the reference vector or line. In some examples, transformed sound field disposer 354 can perform transformations from a head-based coordinate system to a transformed sound field coordinate system (e.g., relative to a reference point on a media device), or vice versa. Transformed sound field disposer 354 can access location definition data 357 in database 356, whereby location definition data 357 includes data describing the effects of different parameter data the influence the disposition or location of a transformed sound field relative to a reference line or a reference point. In some cases, a location at which the transformed sound field is disposed may be based on multiple parameters each of which are weighted in accordance with weighted values defined in location definition data 357.

Therefore, sound field spatial transformer 350 can be configured generate transformed reproduced sound field data 337 which is configured to project spatial audio via speakers 380 to a local recipient. Optionally, sound field spatial transformer 350 can be configured to also generate transformed reproduced sound field data 347 that can be sent to a remote media device for projecting spatial audio to a remote recipient (not shown).

Reproduced sound field translator 336 includes a sound field (“SF”) translator interface 338 and a sound field (“SF”) mapper 339. In some examples, reproduced sound field translator 336 is configured to identify a reproduced sound field generated by, for example, spatial audio generator 360, whereby the reproduced sound field is a three-dimensional reproduction of spatial audio originates from a remote location. Sound field translator interface 338 is configured to receive reproduced sound fields from respective remote sound fields including audio from the respective remote audio sources. Sound field mapper 339 is configured to receive audio data representing the reproduced sound fields. Sound field mapper 339 is also configured to receive data 302 that includes parameters that identify a specific reproduced sound field and the destination location (or an amount of translation) into which the specific reproduced sound field is to be disposed. In some cases, sound field mapper 339 can be implemented as a multiplexer (“MUX”) 337 that receives one or more reproduced sound fields as or associated with translatable portions, such as reproduced sound fields RSF1 and RSF2 (e.g., as one or more translatable portions), and translates them (or multiplexes them) to a different position in a transformed reproduced sound field. For example, RSF1 can be translated into a location initially occupied by RSF2, and, optionally, RSF2 can be translated into another location initially occupied by RSF1. Thereafter, sound field spatial transformer 350 can transform each of the translated reproduced sound fields. MUX 337 can operate in a variety of ways. For example, RSF1 and RSF2 need not be swapped, but can otherwise overlap into a specific portion of the transformed reproduced audio space. In some cases, one of RSF1 and RSF2 can replace the other, with the other of RSF1 and RSF2 being suppressed or otherwise not implemented.

Examples of some components depicted in FIG. 3 are described in U.S. Nonprovisional patent application Ser. No. 13/xxx,xxx, filed MM DD, YYYY with Attorney Docket No. ALI-199, and entitled “Transformation of Multiple Sound Fields to Generate a Transformed Reproduced Sound Field Including Modified Reproductions of the Multiple Sound Fields,” which is herein incorporated by reference in its entirety and for all purposes.

In view of the foregoing, the functions and/or structures of a media device or a sound field spatial transformer 350, as well as their components, can facilitate the determination of positions of audio sources (e.g., listeners) and sizes of transformed reproduced sound field portions, thereby enabling a local listener to aurally identify groups of remote audio sources as well as individual remote audio sources based on, for example, position at which a perceived audio source is disposed. Moreover, a listener can reorient or change directions of perceived audio sources by implementing reproduced sound field translator 336 via an interface to translate reproduced sound fields.

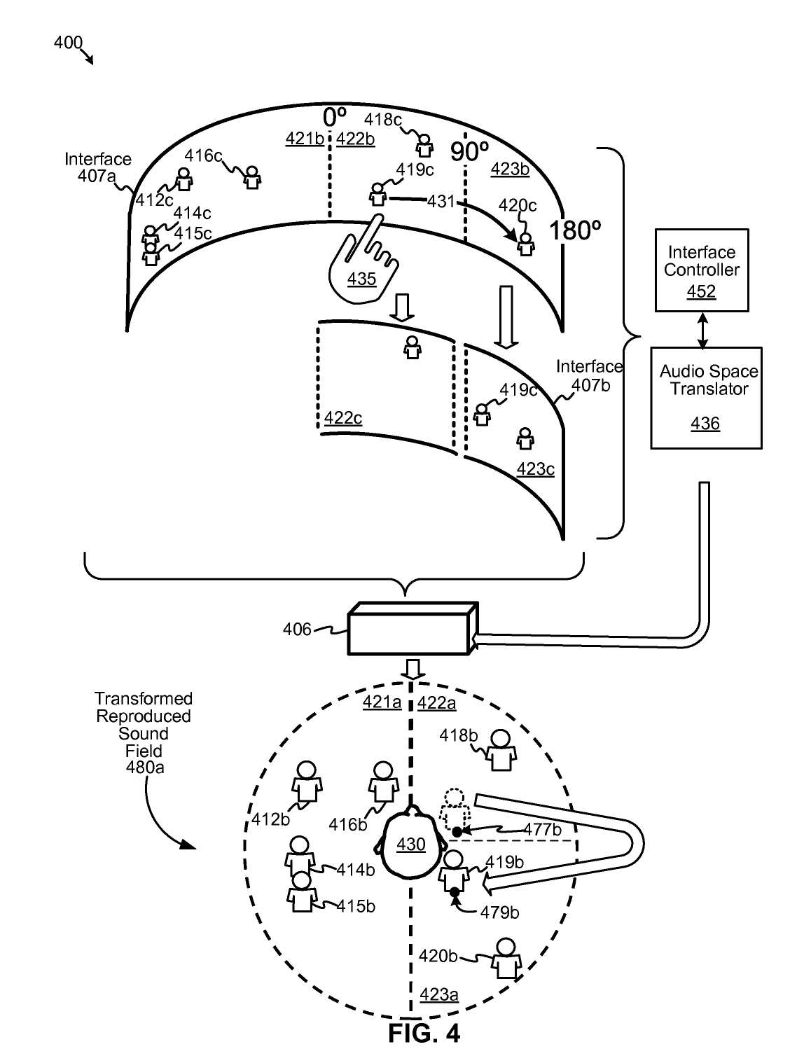

FIG. 4 is a diagram depicting an example of an interface controller and an audio space translator, according to some embodiments. Diagram 400 includes a media device 406, as well as an interface controller 452 coupled to an audio space translator 436. According to various embodiments, audio space translator 436 is configured to receive data from interface controller 452 that specifies that at least one remote audio source (e.g.,), as displayed as an icon on interface 407a, is to be translated from one transformed sound field to another transformed sound field. In particular, while a remote audio source may be generating audio along with other remote audio sources in a common sound field, audio space translator 436 is configured to translate either a remote audio source or a remote audio space, or both, to another reproduced sound field. Therefore, recipient 430 can dispose a perceived audio source such that corresponding audio originates, at least perceptibly, in a direction or position anywhere within transformed reproduced sound field 480a irrespective of the original location at which remote audio source is disposed.

Further to diagram 400, interface controller 452 is configured to receive signals representing interactions by user with an interface 407a. In the example shown, a first portion 421b of interface 407a includes icons 412c to 416c, a second portion 422b of interface 407a includes icons 418c and 419c, and a third portion 423b of interface 407a includes icon 420c. In some examples, each of the above-described portions of interface 407a may correspond to the respective sound field associated with a different remote location. Media device 406 is configured to produce a transformed reproduced sound field 480a that includes a first portion 421a, a second portion 422a, and a third portion 423a. Portion 421a includes perceived audio sources 412b to 416b that are perceived to produce sounds originating to left of recipient 430. Portion 422a includes, at least initially, perceived audio sources 418b and 419b, whereby perceived audio source 419b is initially disposed at position 477b. Portion 423a includes, at least initially, perceived audio source 420b.

To illustrate operation of audio space translator 436, consider the following example in which a user interaction 435 selects icon 419c, and drags that icon a distance 431 to a destination position located in portion 423b of interface 407a. Icon 419c can represent a translatable portion of interface 407a, and/or an associated translatable portion of transformed reproduced sound field 480a. Interface controller 452 detects user interaction 435 and updates, for example, a visual display to depict icon 419c disposed in portion 423c of interface 407b rather than a portion 422c. Note that interfaces 407a and 407b may be the same interface and they depict icons, among other things, at different points in time. Portions 422c and 423c of interface 407b represents portions 422b and 423b of interface 407a, respectively, after receiving input data signals responsive to user interaction 435. Therefore, user interaction 435 causes movement of an icon (e.g., as a translatable portion) in the interface from one portion (e.g., portion 422b) to another portion (e.g., portion 423b). Portion 422b loses an icon (e.g., one icon remains in portion 422c), while portion 423b gains an icon (e.g., one icon is added to portion 423c).

Interface controller 452 configured to determine, for example, an initial point from which icon 419c originates, the destination point to which icon 419c is moved, and/or a length associated with translation of icon 419c over distance 431. Interface controller 452 transmits such information to audio space translator 436, which, in turn, is configured to influence the generation of spatial audio in the formation of transformed reproduced sound field 480a. In particular, audio space translator 436 is configured to modify the spatial audio so that the perception (by recipient 430) that audio is perceived as originating from perceived audio source 419b at position 479b rather than position 477b. In other words, audio space translator 436 is configured to translate perceived audio source 419b, as a translatable portion of transformed reproduced sound field 480a, from position 477b to position 479b. Therefore, while remote audio sources represented by perceived audio sources 418b and 419b are co-located in a common remote location, media device 406 can identify audio from at least one of the remote audio sources and modify its reproduction so that it is perceived to originate at a different location other than its original sound field.

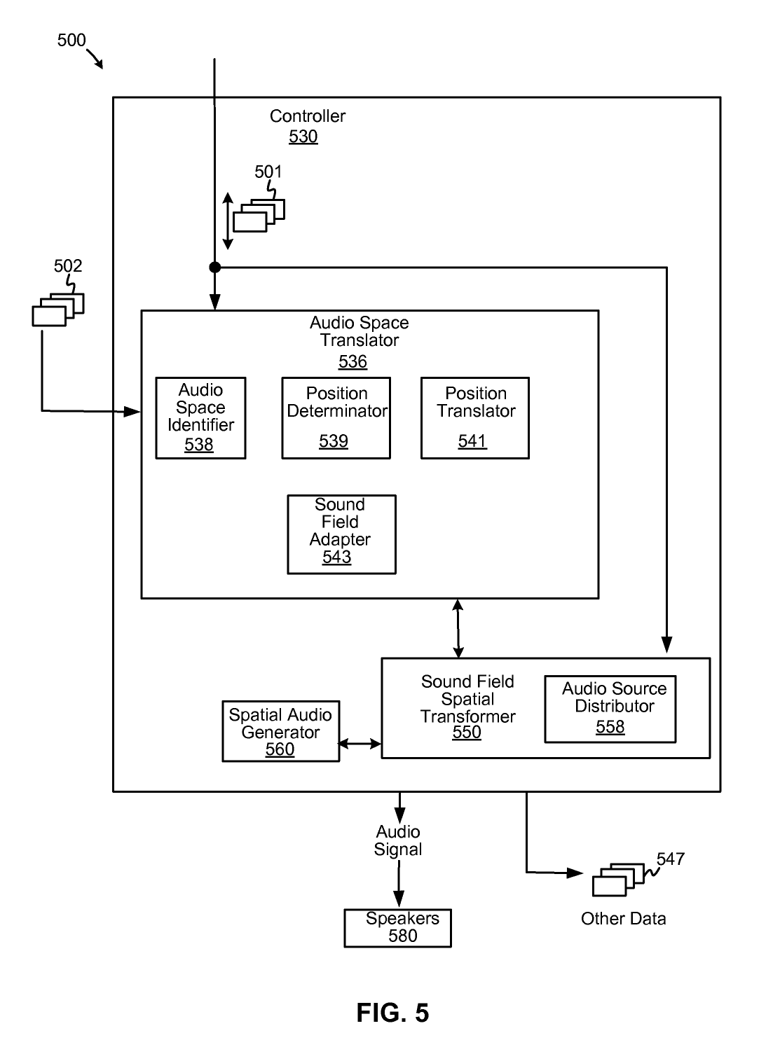

FIG. 5 is a diagram depicting an example of an audio space translator, according to some embodiments. Diagram 500 includes a controller 530, which, in turn, includes an audio space translator 536, a spatial audio generator 560, and a sound field spatial transformer 550. In some embodiments, audio space translator 536 includes an audio space identifier 538, a position determinator 539, a position translator 541, and a sound field adapter 543. Sound field spatial transformer 550 includes an audio source distributor 558. Audio space translator 536 is configured to exchange data 501 with an interface controller (not shown) and to at least receive data 502 that includes a variety of information to facilitate translation of an audio source or audio space in a transformed reproduced sound field. For example, data 501 can include data representing an initial icon position on an interface, a destination icon position of the interface, a distance in which the icon is translated, and the like. As another example, data 502 can include information describing an identity of a device or a remote audio source, and a direction or position of the remote audio source relative to a reference point (e.g., a remote media device). Data 502 can also include data identifying a remote audio source subject to translation (e.g., to identify audio originating from a device or user based on, for example, a user's voice or vocal-related characteristics). In some cases, identification data can include data representing an alpha-numeric identifier associated with either device or a user. Identification of a remote user can be based on a characteristic of the remote user's voice or other user-specific data (e.g., a user's voice frequency, speech cadences, manner of speaking, and the like, among other things). Data 502 also can include data representing audio, such as speech among other things.

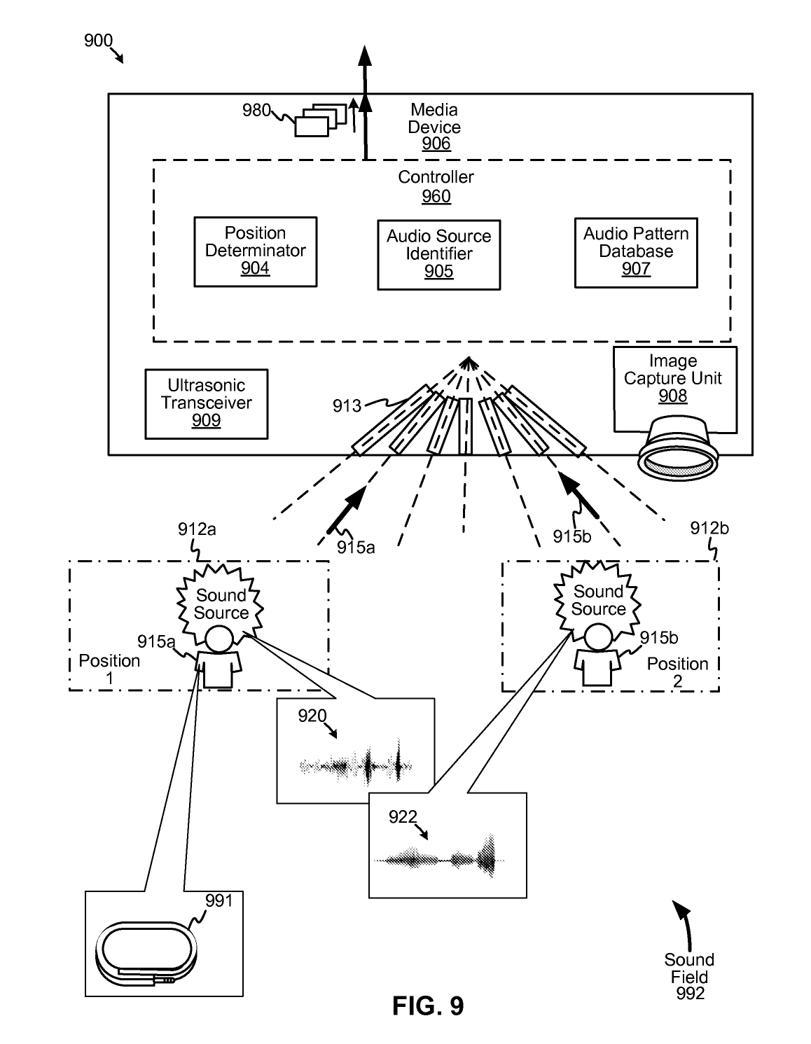

Audio space identifier 538 is configured to identify an audio space or a remote audio source associated with a selected icon. In some cases, identification data can be received via data 502. In other cases, audio space identifier 538 configured to uniquely identify and characterize a source of remote audio for purposes of isolating that audio from other remote audio sources in or adjacent to its remote position. Audio space identifier 530 can transmit an identifier as well as corresponding audio to position determinator 539. Position determinator 539 can determine an initial or approximate position for a remote audio source in two- or three-dimensions, and can correlate that position in a remote sound field to a position of an associated icon on an interface. Position translator 541 is configured to receive data representing a request to translate a perceived audio source based on an interaction with an interface. In particular, position translator 541 is configured to translate a position of a perceived audio source in a reproduced sound field to a different position in the transformed reproduced sound field. For example, position translator 541 can move a perceived audio source by a distance (e.g., in a transformed reproduced sound field) proportional to a distance between a starting and ending point of a moved icon in an interface. In some cases, position determinator 539 can be implemented to determine a position of an audio source is described, for example, in FIG. 9.

Referring back to FIG. 5, sound field adapter 543, while optional, can be configured to modify a destination to accommodate a newly perceived audio source. For example, sound field adapter 543 can increase the size of portion 423a of FIG. 4 to accommodate the added perceived audio source 419b. Referring back to FIG. 5, sound field adapter 543 can transmit data 501 representing the new size of the sound field to an interface controller so that the modified sound field size can be displayed on an interface.

Structures and/or functionality of spatial audio generator 560 and sound field spatial transformer 550 may be equivalent or approximate to the similarly-named and similarly-numbered structures and/or functions as set forth in FIG. 3. Referring back to FIG. 5, audio source distributor 558 can be configured to distribute audio sources in a portion of a transformed reproduced sound field either at equal arc lengths circumferentially about a portion of a circle encompassing a recipient of audio, or at different radial distances from the recipient, or in any other manner. In some examples, audio space translator 536 and/or audio source distributor 558 can translate data representing spatial audio by using data modeled with an HRTF. Such audio then can be transformed by transforming audio based on a head-based coordinate system (e.g., in which azimuth angles, elevation angles, ITDs, and ILDs, among other HRTF parameters, are modeled relative to a point of perceived sound origination from two ears of a head). The head-based audio data then can be transformed into a transformed sound field coordinate system referencing to another point of sound origination in a region external to a media device. As such, audio space translator 536 and/or audio source distributor 558 can modify the position of a perceived audio source (e.g., described in terms of a first coordinate system) to a transformed sound field (e.g., described in a second coordinate system, or described as a second position in the first coordinate system) so that controller 530 can modify the perceived position from which an audio source projects a sound in a portion of the transformed reproduced sound field.

Therefore, sound field spatial transformer 550 can be configured generate transformed reproduced sound field data that is configured to project spatial audio via speakers 580 to a local recipient, whereby perceived audio source can be disposed in a transformed sound field independent of other associated co-located remote audio sources. Optionally, sound field spatial transformer 550 can be configured to also generate transformed reproduced sound field data 547 that can be sent to a remote media device for projecting spatial audio to a remote recipient (not shown). According to various embodiments, the above-described structures and/or functionalities of FIG. 5 can be implemented in a local media device, such as media device 406 of FIG. 4, or in a remote media device (not shown). In some embodiments, one or more components of controller 530 can be distributed over one or more local media devices and/or one or more remote media devices.

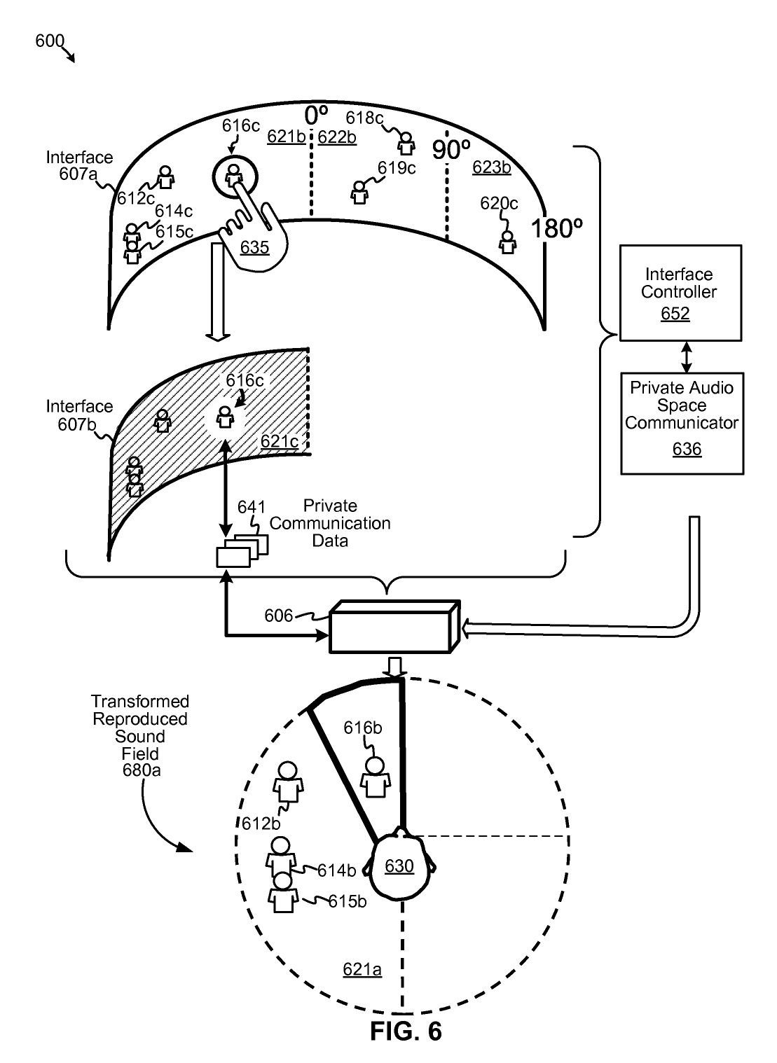

FIG. 6 is a diagram depicting an example of an interface controller and a private audio space communicator, according to some embodiments. Diagram 600 includes a media device 606, as well as an interface controller 652 coupled to a private audio space communicator 636. According to various embodiments, private audio space communicator 636 is configured to receive data from interface controller 652 that specifies that at least one remote audio source, as displayed as an icon on interface 607a, is to its receive a private audio communication from recipient 630. In particular, recipient 630 can interact with interface 607a to identify in remote audio source or remote audio space with which a private communication channel is established. For example, recipient 630 can interact with interface 607a to cause a remote media device, such as media device 146a of FIG. 1A, to control a subset of transducers to steer sound beams towards the targeted recipient of private communication in a remote location.

Further to diagram 600, interface controller 652 is configured to receive signals representing interactions by user with an interface 607a. In the example shown, a first portion 621b of interface 607a includes icons 612c to 616c, a second portion 622b of interface 607a includes icons 618c and 619c, and a third portion 623b of interface 607a includes icon 620c. In some examples, each of the above described portions of interface 607a may correspond to the respective sound field associated with a separate remote location. Media device 606 is configured to produce a transformed reproduced sound field 680a including at least a first portion 621a that includes perceived audio sources. Note that a second portion and a third portion of transformed reproduced sound field 680a need not be described for the present example. Portion 621a is shown to include perceived audio sources 612b to 616b.

To illustrate operation of private audio space communicator 636, consider the following example in which a user interaction 635 selects icon 616c by, for example, tapping on interface 607a (e.g., in the context of, or with data indicating, a request to establish a private channel of communication). Interface controller 652 is configured to detect user interaction 635 (e.g., a user tapping surface of interface 607a that causes generation of an input signal representing a request for private indication), and to identify a remote audio source associated with the selected icon. In some examples, interface controller 652 can cause generation of a visual display to depict icon 616c and the related remote audio source is to receive private data by visually indicating that other remote audio sources, such as those shown in interface portion 607b, are not to receive the private audio (e.g., portion 621c of interface 607b is crosshatched to indicate transmission of the private audio other than to an audio space including remote audio source 616c is reduced, suppressed, or filtered out). While not shown, other remote audio sources likewise may not receive private communications data responsive to the selection of remote audio source 616c.

Private audio space communicator 636 can be configured to determine a location or position in a remote sound field, for example, relative to a reference point (e.g., a remote media device) for forming a private audio space. In some examples, private audio space communicator 636 generates a request via data 641 to establish a private communication channel between recipient 630 and a remote recipient associated with icon 616c. The data of such a request can include an identity of the recipient audio space or audio source, as well as the data representing private audio. Further, private audio space communicator 636 can establish a private link the media device 606 in a remote media device for causing a subset of transducers in the remote media device to steer sound beams towards the position of the selected remote audio source. In some cases, media device 606 transmits the directivity control data that is configured to form the directed sound beams, whereas in other cases the remote media device can generate directivity control data based on the position of the remote audio source that is to receive private audio. In some embodiments, one or more components and/or functions described in diagram 600 can be distributed over one or more local media devices and/or one or more remote media devices.

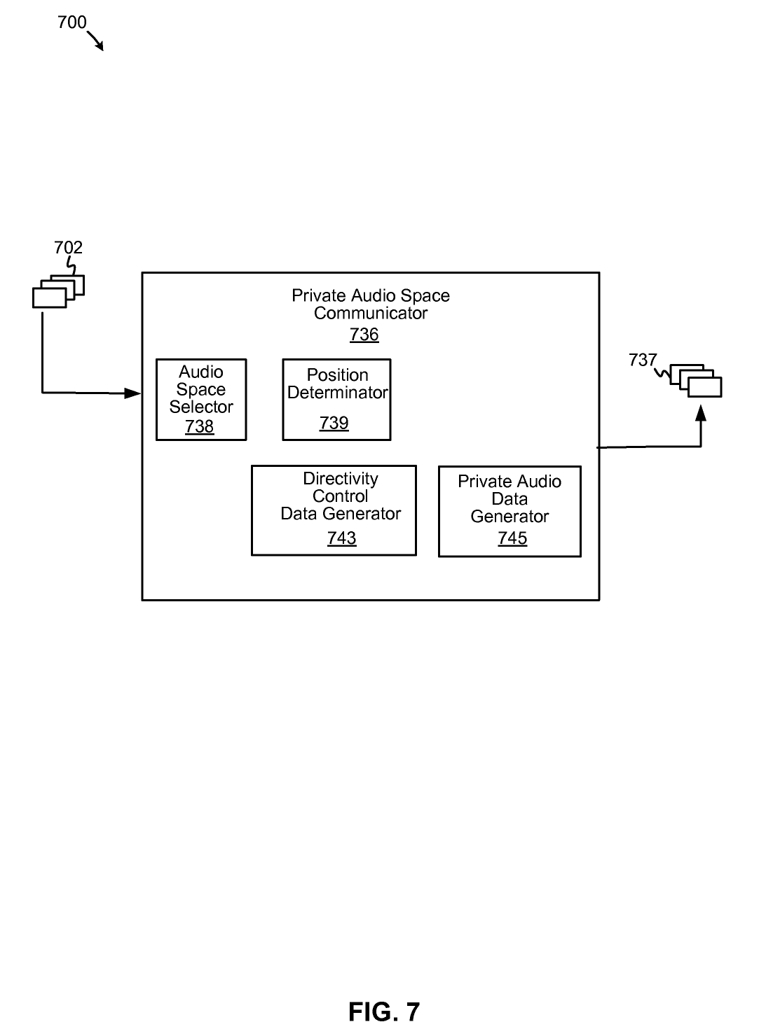

FIG. 7 is a diagram depicting a private audio space communicator, according to some examples. Diagram 700 includes a private audio space communicator 736, which, in turn, includes an audio space selector 738, a position determinator 739, directionality control data generator 743, and a private audio data generator 745. Audio space selector 738 is configured to determine a remote audio source with which a private communication link is to be established. In some examples, data 702 is received by private audio space communicator 736 from an interface controller, whereby data 702 indicates a selected remote audio source that is designated to receive private audio. In some embodiments, data selecting a remote recipient can be received through an interface (not shown).

Position determinator 739 is configured to determine a position in a remote sound field or a remote reproduced sound field at which an audio space is formed to include private audio. Position data is then transmitted to directivity control data generator 743, which uses the position data to modify operation of the subset of transducers to steer sound beams to the position specified by the position data. A recipient of the private data communication disposed at that position can receive private audio data 737 generated by private audio data generator 745. For example, consider that a private audio space communicator 736, when disposed in media device 146a of FIG. 1A, can cause sound beams 142 to direct spatial audio to a remote audio space 144, which includes audio source 116a. Therefore, audio source 116a receives private audio, whereas the audio is imperceptible or substantially imperceptible by other audio sources at the same location.

FIG. 8 illustrates an example of a media device configured to form a transformed reproduced sound field, responsive to interface-originated signals, based on multiple audio streams associated with different media devices, according to some embodiments. Diagram 800 illustrates a media device 806 configured to at least include one or more transducers 840, a controller 870 including a sound field spatial transformer 850 and an interface controller, and various other components (not shown), such as a communications module for communicating, Wi-Fi signals, Bluetooth® signals, or the like. Optionally, media device can communicate with remote media devices 890 via network 810. In some examples, sound field spatial transformer 850 is configured to generate spatial audio for recipients 830a and 830b based on audio from one or more remote regions that include, for example, a remote media device 890. Interface controller 852 is configured to receive input signals from a mobile or wearable device 860 having and an interface 863. Recipient 830a can interact with device 860 via interactions 864 with interface 863 to cause modifications in the manner in which the transformed reproduced sound field is formed, or to cause establishment of the private communications link with a remote audio source 894 (e.g., in “whisper mode”) to convey audio that is imperceptible (or substantially imperceptible) to other listeners adjacent the audio space in which remote audio source 894 is disposed. According to various examples, controller 870 can include more or fewer components, and can include any of the components set forth in controller 101 of FIG. 1A.

Media device 806 is configured to receive audio via microphones 820 (e.g., binaural audio) and to produce audio signals and waveforms to produce sound that can be perceived by a remote audio source 894. In some examples, microphones 822 can be implemented in a surface configured to emulate filtering characteristics of, for example, a pinna of an ear. Optionally, a binaural microphone device 853 can implement binaural microphones 851 for receiving audio and generating binaural audio signals that are transmitted, for example, via a wireless link to media device 806. Examples of microphones device 853 include a mobile phone, computer-integrated eyewear, headsets, or any other electronic device or wearable device. Therefore, media device 806 can transmit audio data 802 to remote media device 890 as a binaural audio stream. In various embodiments, controller 870 is configured to generate 2D or 3D spatial audio locally, such as at audio space 842a and/or at audio space 842b, based on a sound field associated with a remote audio source 894. Also, controller 870 can facilitate or contribute to the generation of reproduced sound field 880a based on audio received from a sound field 880.

According to some embodiments, the remote sound field can be formed as a transformed reproduced sound field (or a reproduce sound field, in some cases) at an audio space 842a and an audio space 842b for local audio sources 830a and 830b, respectively. Note that in some cases, sound field 880 can refer, at least in some examples, to a region from which audio or voices originate (e.g., from local audio sources 830a and 830b), while also receiving propagation of audio and/or sound beams as part of a transformed reproduced sound field based on audio from a remote audio source 894. Similarly, reproduced sound field 880a includes a reproduced spatial audio that include audio originating from local audio sources 830a and 830b, as well as sound originating from remote audio source 894 that is received by media device 890. In some examples, media device 806 receives audio data or audio stream data 801 from one or more remote regions that include one or more remote media devices, such as media device 890, or from a media storing the audio (not shown). Audio stream data 804, at least in this example, originates from other remote media devices that are not shown.

Controller 870 is configured to use the audio data to generate 2D or 3D spatial audio 844a for transmission to recipient 830a. In some embodiments, transducers 840 can generate first sound beam 831 and second sound beam 833 for propagation to the left ear and the right ear, respectively, of recipient 830a. Therefore, sound beams 831 and 833 are generated to form an audio space 842a (e.g., a binaural audio space) in which recipient 830a perceives spatial audio 844a as a transformed reproduced sound field. Transducers 840 cooperate electrically with other components of media device 806, including controller 870, to steer or otherwise direct sound beams 831 and 833 to a point in space at which listener 840a resides and/or at which audio space 842a is to be formed. In some cases, a single left transducer 840a (or loudspeaker) can generate sound beam 831, and a single right transducer 840a (or loudspeaker) can generate sound beam 833, whereby controller 870 can implement a sound field spatial transformer to generate 3-D spatial audio as a transformed reproduced sound field composed of transformed sound fields from different remote locations. Controller 870 can be configured to generate audio space 842a at position 877a by default, whereas in other examples, controller 870 can be configured to modify directivity of sound beams 831 and 833 by steering transducers 840a to aim at position 877a to provide spatial audio 844a to recipient 830a. In particular, controller 870 can receive signals generated from an interaction 864 with an interface, the signals received by interface controller 852 to specify a position 877a to which sound beams 831 and 833 are directed, according to some examples. Therefore, recipient 830a can interact with an interface 863 to modify generation of spatial audio locally or remotely. According to various examples, one or more components of controller 870 can be disposed in media device 806, or can be distributed partially or wholly in other devices, such as mobile device 860. In view of the above, transducers 840a may be sufficient to implement a left loudspeaker and a right loudspeaker to direct sound beam 831 and sound beam 833, respectively, to recipient 830a.

According to various other examples, an array of any number of transducers 840a and 840b can be implemented to form sound beams 831 and 833, which can be controlled by controller 870 in a manner that steers sound beams (that can include the same or different audio) to different positions to form multiple groups of spatial audio. For example, controller 870 can receive data representing positions 877a and 877b for recipients 830a and 830b, respectively, and can control directivity of a first subset of transducers 840a and 840b to direct sound beams 831 and 833 to position 877a, as well as the directivity of a second subset of transducers 840a and 840b to direct sound beams 837 and 839 as spatial audio to position 877b. Remote listener 894 can transmit audio that is presented as spatial audio 840a directed to only audio space 842a, whereby other recipients cannot perceive audio 844a since transducers 840 need not propagate audio 844a to other positions, unless recipient 830b moves into audio space 842a. Therefore, in cases in which media device 890 is structurally and/or functionally similar or equivalent to media device 806, remote audio source 894 can initiate via an interface (not shown) the formation of a private communications link between media device 890 and media device 806, whereby sound beams 831 and 833 include private audio that can be “whispered” to recipient 830a. The private audio thus is imperceptible or substantially imperceptible to recipient 830b.

Note that transducers 840b can be implemented along with transducers 840a to form arrays or groups of any number of transducers operable as loudspeakers, whereby the groups of transducers need not be aligned in rows and columns and can be arranged and sized differently, according to some embodiments. Note that while recipients 830a and 830b are described as such (i.e., recipients of audio), recipients 830a and 830b each can be audio sources, too, and can represent the same audio source at different times. In some cases, recipients 830a and 830b need not be animate, but can be audio devices.

Controller 870 can generate spatial audio using a subset of spatial audio generation techniques that implement digital signal processors, digital filters, and the like to provide perceptible cues for recipients 830a and 830b to correlate spatial audio 844a and 844b, respectively, with perceived positions from which the audio originate. In some embodiments, controller 870 is configured to implement a crosstalk cancellation filter (and corresponding filter parameters), or variant thereof, as disclosed in published international patent application WO2012/036912A1, which describes an approach to producing cross-talk cancellation filters to facilitate three-dimensional binaural audio reproduction. In some examples, controller 870 includes one or more digital processors and/or one or more digital filters configured to implement a BACCH® digital filter, an audio technology developed by Princeton University of Princeton, N.J. In some examples, controller 870 includes one or more digital processors and/or one or more digital filters configured to implement LiveAudio® as developed by AliphCom of San Francisco, Calif.

According to some embodiments, media device 806 and/or controller 870 can determine or otherwise receive position data describing positions 877a and 877b of recipients 830a and 830b, respectively. Position data can specify relative distances (e.g., magnitudes of vectors) and directions (e.g., angular displacement of vectors relative to a reference) of audio sources and other aspects of sound field 880, including the dimensions of a room and the like. For example, position 877a can be described in terms of a magnitude or a direction of ray line 828 extending from reference point 824 at an angle 826 relative to a front surface of media device 806. In some examples, controller 870 determines distances (and variations thereof) and directions (and variations thereof) for a position of recipient 830a to modify operation of, for example, a cross-talk filter (e.g., angles or directions from transducers 840 to a recipient's ears) and/or steerable transducers to alter directivity of spatial audio toward a recipient 830a in sound field 880.

Position data describing the positions 877a and 877b of recipients 830a and 830b, respectively, can be transmitted to media device 890, at least in some examples. Other data regarding the recipients 830a and 830b, such as identification data and the like, also can be transmitted to media device 890. Controller 870 and/or a controller in media device 890 can implement the position and identification data to establish a private communication link from remote audio source 894 to, for example, recipient 830a. Further, controller 870 and/or a controller in media device 890 can translate a reproduced sound field version of sound field 880 with another reproduced sound field (not shown), or can translate a perceived audio source from one transformed sound field to another transformed sound field, as described the various examples set forth herein

In some examples, controller 870 can be configured to transmit control data 803 from media device 806 to remote audio system 890. In some embodiments, control data 803 can include information describing, for example, how to form a reproduced sound field 880a. Remote audio system 890 can use control data 803 to reproduce sound field 880 by generating sound beams 835a and 835b for the right ear and left ear, respectively, of remote listener 894. In further examples, control data 803 may include parameters to adjust a crosstalk filter, including but not limited to distances from one or more transducers to an approximate point in space in which a listener's ear is disposed, calculated pressure to be sensed at a listener's ear, time delays, filter coefficients, parameters and/or coefficients for one or more transformation matrices, and various other parameters. Remote listener 894 may perceive audio generated by audio source 830a as originating from a position of audio space 842a relative to, for example, a point in space coinciding with the location of the remote audio system 890 (not shown). In particular, remote listener 894 can perceive audio sources (e.g., associated with audio sources 830a and 830b) and their perceived spatial arrangement relative to media device 890 in reproduced sound field 880a.

In some cases, remote audio system 890 includes logic, structures and/or functionality similar to that of controller 870 of media device 806. But in some cases, remote audio system 890 need not include a controller. As such, controller 870 can generate spatial audio that can be perceived by remote listener 894 regardless of whether remote audio system 890 includes a controller. That is, remote audio system 890, which can provide binaural audio, can use audio data 802 to produce spatial binaural audio via, for example, sound beams 835a and 835b without a controller, according to some embodiments. In some embodiments, media device 890 can receive audio data 804 as well as other control data from other media devices (not shown) to present sound beams 835a and 835b as a transformed reproduced sound field including a transformed version of sound field 880. Alternatively, controller 870 of media device 806 can used control data, similar to control data 803, to generate spatial audio 844a and 844b by receiving audio from remote audio system 890 (e.g., need not be similar to media device 806) and applying control data to reproduce the sound field associated with the remote listener 894 for recipient 830a. A controller (not shown) disposed in remote audio system 890 can generate the control data, which is transmitted as part of audio data 801. In some cases, the controller disposed in remote audio system 890 can generate the spatial audio to be presented to recipient 830a regardless of whether media device 806 includes controller 870. That is, the controller disposed in remote audio system 890 can generate the spatial audio in a manner that the spatial effects can be perceived by a listener 840 via any audio presentation system configured to provide binaural audio.

Examples of components or elements of an implementation of media device 806, including as least some of those components used to determine proximity of a listener (or audio source), are disclosed in U.S. patent application Ser. No. 13/831,422, entitled “Proximity-Based Control of Media Devices,” filed on Mar. 14, 2013 with Attorney Docket No. ALI-229, which is incorporated herein by reference. In various examples, media device 806 is not limited to presenting audio, but rather can present both visual information, including video (e.g., using a pico-projector digital video projector or the like) or other forms of imagery along with (e.g., synchronized with) audio. According to at least some embodiments, the term “audio space” can refer to a two- or three-dimensional space in which sounds can be perceived by a listener as 2D or 3D spatial audio. The term “audio space” can also refer to a two- or three-dimensional space from which audio originates, whereby an audio source can be co-located in the audio space. For example, a listener can perceive spatial audio in an audio space, and that same audio space (or variant thereof) can be associated with audio generated by the listener, such as during a teleconference. The audio space from which the audio originates can be reproduced at a remote location as part of reproduced sound field 880a. In some cases, the term “audio space” can be used interchangeably with the term “sweet spot.” In at least one non-limiting implementation, the size of the sweet spot can range from two to four feet in diameter, whereby a listener can vary its position (i.e., the position of the head and/or ears) and maintain perception of spatial audio. Various examples of microphones that can be implemented as microphones 820 and 851 include directional microphones, omni-directional microphones, cardioid microphones, Blumlein microphones, ORTF stereo microphones, binaural microphones, arrangements of microphones (e.g., similar to Neumann KU 100 binaural microphones or the like), and other types of microphones or microphone systems.

FIG. 9 depicts an example of a media device including a controller configured to determine position data and/or identification data regarding one or more audio sources, according to some embodiments. In this example, diagram 900 depicts a media device 906 including a controller 960, an ultrasonic transceiver 909, an array of microphones 913, and an image capture unit 908, one or more of which may be optional. Controller 960 is shown to include a position determinator 904, an audio source identifier 905, and an audio pattern database 907. Position determinator 904 is configured to determine a position 912a of an audio source 915a, and a position 912b of an audio source 915b relative to, for example, a reference point coextensive with media device 906. In some embodiments, position determinator 904 is configured to receive position data from a wearable device 991 which may include a geo-locational sensor (e.g., a GPS sensor) or any other position or location-like sensor. An example of a suitable wearable device, or a variant thereof, is described in U.S. patent application Ser. No. 13/454,040, which is incorporated herein by reference. In other examples, position determinator 904 can implement one or more of ultrasonic transceiver 909, array of microphones 913, and image capture unit 908, etc.

Ultrasonic transceiver 909 can include one or more acoustic probe transducers (e.g., ultrasonic signal transducers) configured to emit ultrasonic signals to probe distances and/or locations relative to one or more audio sources in a sound field. Ultrasonic transceiver 909 can also include one or more ultrasonic acoustic sensors configured to receive reflected acoustic probe signals (e.g., reflected ultrasonic signals). Based on reflected acoustic probe signals (e.g., including the time of flight, or a time delay between transmission of acoustic probe signal and reception of reflected acoustic probe signal), position determinator 904 can determine positions 912a and 912b. Examples of implementations of one or more portions of ultrasonic transceiver 909 are set forth in U.S. Nonprovisional patent application Ser. No. 13/954,331, filed Jul. 30, 2013 with Attorney Docket No. ALI-115, and entitled “Acoustic Detection of Audio Sources to Facilitate Reproduction of Spatial Audio Spaces,” and U.S. Nonprovisional patent application Ser. No. 13/954,367, filed Jul. 30, 2013 with Attorney Docket No. ALI-144, and entitled “Motion Detection of Audio Sources to Facilitate Reproduction of Spatial Audio Spaces,” each of which is herein incorporated by reference in its entirety and for all purposes.

Image capture unit 908 can be implemented as a camera, such as a video camera. In this case, position determinator 904 is configured to analyze imagery captured by image capture unit 908 to identify sources of audio. For example, images can be captured and analyzed using known image recognition techniques to identify an individual as an audio source, and to distinguish between multiple audio sources. Based on the relative size of an audio source in one or more captured images, position determinator 904 can determine an estimated distance relative to, for example, image capture unit 908. Further, position determinator 904 can estimate a direction based on the portion in which the audio sources captured relative to the field of view (e.g., potential audio source captured in a right portion of the image can indicate the audio source may be in the direction of approximately 60 to 90° to a normal vector).

Microphones (e.g., in array of microphones 913) can each be configured to detect or pick-up sounds originating at a position or a direction. Position determinator 904 can be configured to receive acoustic signals from each of the microphones or directions from which a sound, such as speech, originates. For example, a first microphone can be configured to receive speech originating in a direction 915a from a sound source at position 912a, whereas a second microphone can be configured to receive sound originating in a direction 915b from a sound source at position 912b. For example, position determinator 904 can be configured to determine the relative intensities or amplitudes of the sounds received by a subset of microphones and identify the position (e.g., direction) of a sound source based on a corresponding microphone receiving, for example, the greatest amplitude. In some cases, a position can be determined in three-dimensional space. Position determinator 904 can be configured to calculate the delays of a sound received among a subset of microphones relative to each other to determine a point (or an approximate point) from which the sound originates. Delays can represent farther distances a sound travels before being received by a microphone. By comparing delays and determining the magnitudes of such delays, in, for example, an array of transducers operable as microphones, the approximate point from which the sound originates can be determined. In some embodiments, position determinator 904 can be configured to determine the source of sound by using known time-of-flight and/or triangulation techniques and/or algorithms.

Audio source identifier 905 is configured to identify or determine identification of an audio source. In some examples, an identifier specifying the identity of an audio source can be provided via a wireless link from wearable device, such as wearable device 991. According to some other examples, audio source identifier 905 is configured to match vocal waveforms received from sound field 992 against voice-based data patterns in an audio pattern database 907. For example, vocal patterns of speech received by media device 906, such as patterns 920 and 922, can be compared against those patterns stored in audio pattern database 907 to determine the identities audio source 915a and 915b, respectively, upon detecting a match. By identifying an audio source, controller 960 can transform a position of the specific audio source, for example, based on its identity and other parameters, such as the relationship to recipient of spatial audio. Further, controller 960 can include a private audio space communicator (not shown) that is configured to receive signals from an interface (not shown), and further configured to form a private communications link to provide private audio to a remote audio source or listener. The private audio space communicator can use position data, identification data, and/or other data facilitate the formation of the private communications link to a remote audio source at a specific location having a specific identity. In view of the foregoing, audio sources, therefore, can be positioned differently in a transformed sound field, responsive to interface interactions, than the arrangement in the original sound field.

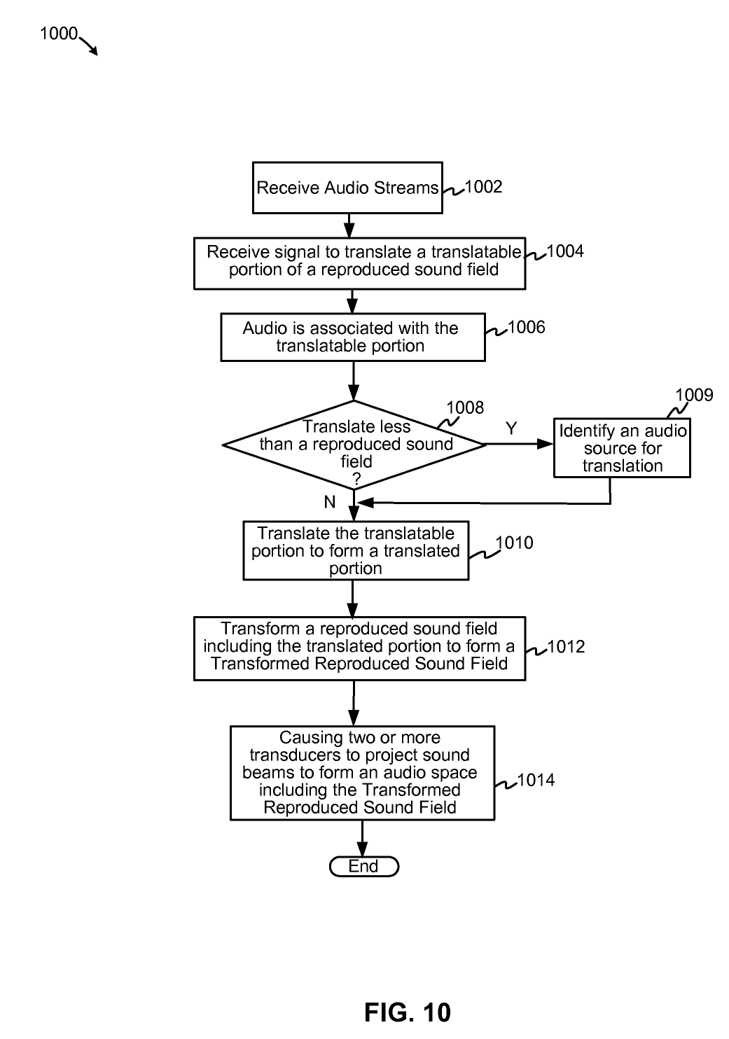

FIG. 10 is an example flow of controlling transformation of sound fields to include translated portions, according to some embodiments. Flow 1000 starts by receiving multiple audio streams at 1002 each audio stream representing one or more remote audio sources for a particular remote sound field. At 1004, signals requesting to translate a translatable portion of a reproduced sound field are received. Such signals can include a request to translate an icon to cause translation of a remote audio source from one position to another position of a transformed reproduced sound field. Alternatively, a signal can include a request to translate a group of icons associated with a common location as perceived audio spaces (i.e., translate remote audio sources of a common reproduced sound field within a transformed reproduced sound field). At 1006, audio is associated with the translated portion, the audio to being identified for purposes of translation. At 1008, a determination is made whether to translate less than a reproduced sound field. If so, an audio source for translation is identified for translation at 1009, otherwise flow 1000 identifies a group of audio sources and moves to 1010. The translatable portion is translated to form a translated portion at 1010. At 1012, a reproduced sound field including the translated portion is transformed to form a transformed reproduced sound field. At 1014, transducers (e.g., two or more transducers) are initiated to project sound beams to forma an audio space including the transformed reproduced sound field.

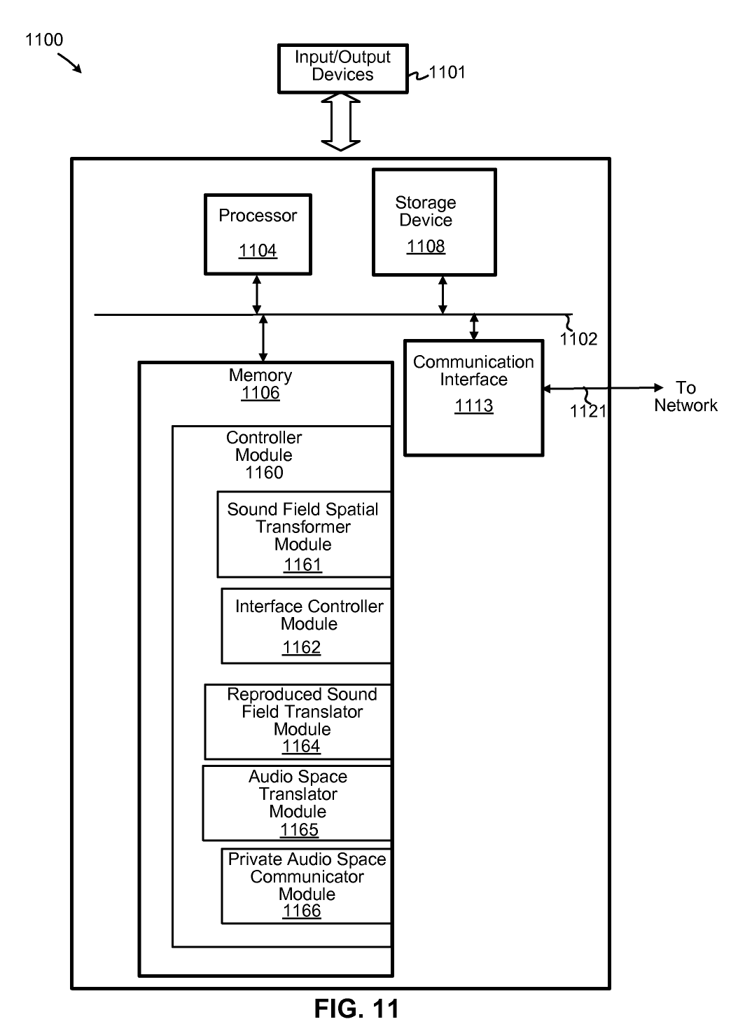

FIG. 11 illustrates an exemplary computing platform disposed in a media device, a wearable device, or a mobile computing device in accordance with various embodiments. In some examples, computing platform 1100 may be used to implement computer programs, applications, methods, processes, algorithms, or other software to perform the above-described techniques. Computing platform 1100 includes a bus 1102 or other communication mechanism for communicating information, which interconnects subsystems and devices, such as processor 1104, system memory 1106 (e.g., RAM, etc.), storage device 1108 (e.g., ROM, etc.), a communication interface 1113 (e.g., an Ethernet or wireless controller, a Bluetooth controller, etc.) to facilitate communications via a port on communication link 1121 to communicate, for example, with a computing device, including mobile computing and/or communication devices with processors. Processor 1104 can be implemented with one or more central processing units (“CPUs”), such as those manufactured by Intel® Corporation, or one or more virtual processors, as well as any combination of CPUs and virtual processors. Computing platform 1100 exchanges data representing inputs and outputs via input-and-output devices 1101, including, but not limited to, keyboards, mice, audio inputs (e.g., speech-to-text devices), user interfaces, displays, monitors, cursors, touch-sensitive displays, LCD or LED displays, and other I/O-related devices.

According to some examples, computing platform 1100 performs specific operations by processor 1104 executing one or more sequences of one or more instructions stored in system memory 1106, and computing platform 1100 can be implemented in a client-server arrangement, peer-to-peer arrangement, or as any mobile computing device, including smart phones and the like. Such instructions or data may be read into system memory 1106 from another computer readable medium, such as storage device 1108. In some examples, hard-wired circuitry may be used in place of or in combination with software instructions for implementation. Instructions may be embedded in software or firmware. The term “computer readable medium” refers to any tangible medium that participates in providing instructions to processor 1104 for execution. Such a medium may take many forms, including but not limited to, non-volatile media and volatile media. Non-volatile media includes, for example, optical or magnetic disks and the like. Volatile media includes dynamic memory, such as system memory 1106.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read. Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 1102 for transmitting a computer data signal.

In some examples, execution of the sequences of instructions may be performed by computing platform 1100. According to some examples, computing platform 1100 can be coupled by communication link 1121 (e.g., a wired network, such as LAN, PSTN, or any wireless network) to any other processor to perform the sequence of instructions in coordination with (or asynchronous to) one another. Computing platform 1100 may transmit and receive messages, data, and instructions, including program code (e.g., application code) through communication link 1121 and communication interface 1113. Received program code may be executed by processor 1104 as it is received, and/or stored in memory 1106 or other non-volatile storage for later execution.

In the example shown, system memory 1106 can include various modules that include executable instructions to implement functionalities described herein. In the example shown, system memory 1106 includes a controller module 1160, which, in turn, can include one or more of a sound field spatial transformer module 1161, an interface controller module 1162, a reproduced sound field translator module 1164, an audio space translator module 1165, and a private audio space communicator module 1166, each of which can be configured to provide one or more functions described herein.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

What is claimed:

1. A method comprising:
receiving audio streams including data representing audio originating from subsets of one or more audio sources at positions in separate sound fields, each of the sound fields associated with a reference point;
receiving a signal including data representing an instruction to cause a translatable portion of a reproduced sound field to translate from a first portion of the reproduced sound field to a second portion of the reproduced sound field;
associating the translatable portion with audio to be translated;
translating the translatable portion to form a translated portion;
transforming at a processor at least the second portion of the reproduced sound field in which the audio of the translated portion is disposed to form a transformed reproduced sound field; and
causing transducers to project sound beams at a point in a region to form an audio space at which spatial audio is produced to include the transformed reproduced sound field.

2. The method of claim 1, wherein receiving the signal including the data representing the instruction comprises:
detecting a selection associated with a user interface, the selection being of a representation of the translatable portion of the reproduce sound field;
receiving data representing an amount of translation of the representation of the translatable portion associated with the user interface; and
disposing the translated portion in the transformed reproduced sound field as a function of the amount of translation associated with the user interface.

3. The method of claim 2, wherein detecting selection of the representation of the translatable portion comprises:
detecting selection of a representation of a sound field as the translatable portion of the reproduce sound field; and
disposing the sound field in the transformed reproduced sound field based on the amount of translation associated with the user interface.

4. The method of claim 2, wherein detecting selection of the representation of the translatable portion comprises:
detecting selection of a representation of an audio source in a sound field as the translatable portion of the reproduce sound field;
determining a translation of the audio source from the sound field to another sound field based on the amount of translation associated with the user interface; and
disposing the audio source from the sound field associated with a reproduced sound field in another reproduced sound field associated with the another sound field.

5. The method of claim 1, wherein receiving the signal including the data representing the instruction comprises:
detecting selection of a representation of a sound field as the translatable portion of the reproduce sound field;
mapping a position of the sound field in the transformed reproduced sound field to another position of another sound field in the transformed reproduced sound field; and
disposing a reproduced sound field of the sound field in the another position.

6. The method of claim 5, wherein mapping the position of the sound field comprises:
multiplexing the reproduced sound field for the sound field with another reproduced sound field for the another sound field to form multiplexed reproduced sound fields.

7. The method of claim 1, wherein receiving the signal including the data representing the instruction comprises:
detecting selection of a representation of an audio source in a sound field as the translatable portion of a reproduce sound field;
identifying the audio source in the sound field; and
determining a position of the audio source in the sound field.

8. The method of claim 7, further comprising:
translating the position of the audio source from the reproduced sound field to a destination in the transformed reproduced sound field.

9. The method of claim 7, further comprising:
disposing the audio source from the sound field among other audio sources associated with another sound field in the transformed reproduced sound field.

10. The method of claim 9, further comprising:
adapting distribution of the other audio sources in the transformed reproduced sound field to compensate for disposition of the audio source.

11. The method of claim 9, further comprising:
adapting a portion of the transformed reproduced sound field to compensate for disposition of the audio source.

12. The method of claim 11, wherein adapting the portion of the transformed reproduced sound field comprises:
changing the size of the portion of the transformed reproduced sound field.

13. The method of claim 1, further comprising:
selecting a location relative to one of the reference points at which to form a private audio space.

14. The method of claim 13, further comprising:
determining the location of the private audio space; and
generating directivity control data configured to form directed sound beams to form the private audio space.

15. The method of claim 14, further comprising:
generating audio data for transmission to the private audio space,
wherein the audio data includes a message directed to a listener disposed in the private audio space.

16. A system comprising:
a media device comprising:
a plurality of transducers configured to emit acoustic signal into an adjacent region;
a memory including executable instructions; and
a processor configured to:
execute a first portion of the executable instructions to receive audio streams including data representing audio originating from subsets of one or more audio sources at positions in separate sound fields, each of the sound fields associated with a reference point;
execute a second portion of the executable instructions to receive a signal including data representing an instruction to cause a translatable portion of a reproduced sound field to translate from a first portion of the reproduced sound field to a second portion of the reproduced sound field;
execute a fourth portion of the executable instructions to translate the translatable portion to form a translated portion;
execute a fifth portion of the executable instructions to transform at least the second portion of the reproduced sound field in which the audio of the translated portion is disposed to form a transformed reproduced sound field; and
execute a sixth portion of the executable instructions to cause transducers to project sound beams at a point in the adjacent region to form an audio space at which spatial audio is produced to include the transformed reproduced sound field.

17. The system of claim 16, wherein the processor is further configured to:
execute a seventh portion of the executable instructions detect a selection associated with a user interface, the selection being of a representation of the translatable portion of the reproduce sound field;
execute an eighth portion of the executable instructions to receive data representing an amount of translation of the representation of the translatable portion associated with the user interface; and
execute a ninth portion of the executable instructions to dispose the translated portion in the transformed reproduced sound field as a function of the amount of translation associated with the user interface.

18. The system of claim 17, further comprising:
a reproduced sound field translator configured to translate the reproduced sound field as the translatable portion.

19. The system of claim 17, further comprising:
an audio space translator configured to translate a perceived position of a remote audio source as the translatable portion.

20. The system of claim 17, further comprising:
a private audio space communicator configured to establish a private communications link to a remote audio space.
